(19) United States
(12) Patent Application Publication
(10) Pub. No.: US 2026/0082255 A1
(43) Pub. Date: Mar. 19, 2026

(54) QUALITY OF EXPERIENCE (QOE) AND/OR RADIO ACCESS NETWORK VISIBLE QOE (RVQOE) CONFIGURATION AND REPORTING FOR MULTICAST AND BROADCAST SERVICE (MBS)

(71) Applicant: Telefonaktiebolaget LM Ericsson (publ), Stockholm (SE)

(72) Inventors: Luca LUNARDI, Genoa (IT); Johan RUNE, Lidingö (SE); Cecilia EKLÖF, Täby (SE); Agne CIUCIULKAITE, Uppsala (SE); Filip BARAC, Huddinge (SE)

(21) Appl. No.: 19/109,037

(22) PCT Filed: Sep. 26, 2023
(86) PCT No.: PCT/SE2023/050940

§ 371 Date: Mar. 5, 2025

Related U.S. Application Data
(60) Provisional application No. 63/410,498, filed on Sep. 27, 2022.

(51) Int. Cl. H04W 24/10; H04W 4/06

(52) U.S. Cl. CPC H04W 24/10; H04W 4/06

(57) ABSTRACT

A method, system and apparatus are disclosed. According to some embodiments, a network node is configured to: one of receive from another network node or determine a first level quality of experience, QoE, configuration item for multicast and broadcast service, MBS, and one of receive from the other network node or determine a second level QoE configuration item for the MBS, where the second level QoE configuration is different from the first level QoE configuration item and associated with an application whose data is delivered by the MBS. The network node is configured to indicate, to the wireless device, the first level QoE configuration item and second level QoE configuration item for the wireless device to perform an action based on at least one of the first level QoE configuration item or second level QoE configuration item.

### TECHNICAL FIELD

The present disclosure relates to wireless communications, and in particular, to quality of experience, QoE, configuration for multicast and broadcast service, MBS.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) standards for wireless communication networks are also under development.

### Overview of the QoE Framework

### Legacy QoE Measurements

Quality of Experience (QoE) measurements, also referred to as “application layer measurements”, have been specified for LTE, UMTS and were recently specified for 5G NR in the 3GPP Release 17 (Rel-17). The purpose of the QoE measurements is to measure the experience of the end user using certain applications. Currently the QoE measurements are specified and supported for DASH streaming, MTSI (Mobility Telephony Service for IMS) services, and VR.

The solutions in long term evolution (LTE) and universal mobile telecommunication systems (UMTS) are similar with the overall principles as follows. QoE Measurement Collection (QMC) enables configuration of application layer measurements in the wireless device and transmission of QoE measurement result files, commonly referred to as “QoE reports”, to the network node by means of radio resource control (RRC) signalling. An application layer measurement configuration (also called QoE measurement configuration or QoE configuration) that the radio access network (RAN) receives from the operations, administration and maintenance (OAM) system, or the CN (e.g., core node), is encapsulated in a transparent container, which is forwarded to a wireless device in a downlink RRCReconfiguration message. An application layer measurement report (also called QoE report) that the UE (e.g., wireless device) Access Stratum (UE AS) or wireless device RRC layer receives from the wireless device's higher layer (application layer) is encapsulated in a transparent container and sent to the network in an uplink RRC message, MeasurementAppLayerReport. The RAN then forwards the QoE report to a Measurement Collector Entity (MCE).

In 3GPP Rel-17 “Study on NR QoE management and optimizations for diverse services” with the purpose to study solutions for QoE measurements in NR was discussed. According to this item, QoE management in NR will not just collect the QoE parameters of streaming services but also consider the typical performance requirements of diverse services (e.g., augmented reality/virtual reality (AR/VR) and ultra-reliable low latency communication (URLLC), of which at least VR was covered in 3GPP Rel-17). Based on requirements of services, the NR study also included more adaptive QoE management schemes that enable network optimization to satisfy user experience for diverse services.

The configuration data related to QoE measurements (in standard specifications (e.g., 3GPP specifications) typically referred to as application layer measurements) consists of a service type indication, an indication of an area in which the measurements are to be performed (denoted area scope), an IP address of the entity the collected measurement results (i.e., the QoE reports) should be sent to (often referred to as a MCE or Measurement Collector Entity or Measurement Collection Entity) and a set of instructions of which type of measurements that should be performed and details of how these measurements are to be performed. These instructions are intended for the application layer in the wireless device and are placed in a “container” which cannot be read and interpreted by the network entities handling it, e.g., forwarding it to the wireless device, as well as the UE Access Stratum. The currently specified service types are MTSI (e.g., multimedia telephony service for IMS) and streaming service (DASH), and in 3GPP Rel-17, VR was added. An area scope is defined in terms of cells or network related areas. In UMTS, an area scope is defined as either a list of cells, a list of routing areas, or a list of tracking areas. In LTE, an area scope is defined as either a list of cells or a list of tracking areas. In NR, an area scope is defined as either a list of cells or a list of tracking areas.

QoE, and in particular, the QoE configuration, comes in two versions: management-based (m-based) QoE configuration and signaling-based (s-based) QoE configuration. In both cases, the QoE configuration originates in the OAM system or some other administrational entity, e.g., dealing with customer satisfaction. All of these entities are in this document referred to as the OAM system (where the OAM system also contains further entities).

With the m-based QoE, the OAM system is typically interested in general QoE statistics from a certain area, configured as an area scope. The m-based QoE configuration is sent directly from the OAM system to the RAN nodes controlling cells that are within the area scope. Each RAN node then selects wireless devices that are within the area scope (and also fulfills any other relevant condition, such as supporting the concerned application/service type) and sends the m-based QoE configuration to these wireless devices.

With the s-based QoE, the OAM system is interested in collecting QoE measurement results from a specific wireless device, e.g., because the user of the wireless device has filed a complaint. The OAM system sends the s-based QoE configuration to the home subscriber server (HSS) (in evolved packet system (EPS)/LTE) or unified data manager (UDM) (in 5GS/NR), which forwards the QoE configuration to the wireless device's current core network node (CN), e.g., a mobility management entity (MME) in EPS/LTE or an access and mobility management function (AMF) in 5G/NR. The CN then forwards the s-based QoE configuration to the RAN node that serves the concerned wireless device and the RAN forwards it to the wireless device.

Forwarded to the wireless device are the service type indication and the container with the measurement instructions. The wireless device is not aware of whether a received QoE configuration is m-based or s-based. In legacy systems (e.g., legacy 3GPP systems), the QoE framework is integrated with the Trace functionality and a Trace ID is associated with each QoE configuration. In NR, the QoE functionality is logically separated from the Trace functionality, but it will still partly reuse the Trace signaling mechanisms. In NR, and possibly in LTE, a globally unique QoE reference (formed of MCC+MNC+QMC ID, where the QMC ID is a string of 24 bits) will be associated with each QoE configuration. The QoE reference is included in the container with measurement instructions and also sent to the RAN (i.e., the network node (e.g., gNB) in NR). For the communication between the network node and the wireless device, the QoE reference is replaced by a shorter identifier denoted as measConfigAppLayerId, which is locally unique within a wireless device (i.e., there is a one-to-one mapping between a measConfigAppLayerId and a QoE reference for each QoE configuration provided to a wireless device. The measConfigAppLayerId is stored in the UE Access Stratum and also forwarded in an AT Command (which is the type of instructions used in the communication between the wireless device's modem part and the wireless device's application layer) together with the service type indication and the container with the measurement instructions.

Reports with collected QoE reports are sent from the wireless device application layer to the UE Access Stratum, which forwards them to the RAN, which in turn forwards them to the MCE (e.g., Multi-cell/multicast Coordination Entity). These QoE reports are placed in a “container”, which is uninterpretable for both the UE Access Stratum and the RAN. QoE reporting can be configured to be periodic or only to be sent at the end of an application session. Furthermore, the RAN can instruct the wireless device to pause QoE reporting, e.g., in case the cell/network node is in a state of overload.

The RAN is not automatically aware of when an application session with an associated QoE measurement session is ongoing, and the UE Access Stratum is also not automatically aware of this. To alleviate this session “start”/“stop” indications which are sent from the application layer in the wireless device to the UE AS and from the UE AS to the RAN were introduced. A session “stop” indication may be explicit or may be implicit in the form of a QoE report sent when the application session and the associated QoE measurement session are concluded.

The RAN may decide to release a QoE configuration in a wireless device at any time, as an implementation-based decision. Typically, it is performed when the wireless device has moved outside a configured area scope.

One opportunity provided by legacy solutions is also to be able to keep the QoE measurement for the whole session, even during a handover situation. It is also discussed to let the wireless device continue with the QoE measurements on an ongoing application session until the application session ends, even if the wireless device in the meantime moves out of the configured area scope.

### Multicast and Broadcast Service Overview

### General

Multicast and Broadcast Service (MBS) is a point-to-multipoint service in which services and data are transmitted from a single source entity to multiple recipients, either to all wireless devices in a Broadcast service area, or to wireless devices/users in a multicast group as defined in 3GPP Technical Specification (TS) 23.247.

3GPP 5G NR system enables delivery of Multicast Broadcast Service (MBS) in a resource-efficient way. Via the MBS, the same service and the same specific content data from a single source can be provided simultaneously to all wireless devices in a geographical area (in the broadcast communication service) or to a dedicated set of wireless devices (in the multicast communication service). That is, all wireless devices in a broadcast area can receive the data, while not all wireless devices are authorized to receive the data in a multicast area.

A wireless device can receive a broadcast MBS communication service independently of its RRC state, while a multicast MBS service can be received only by the wireless device in the RRC_CONNECTED state. Multicast communication data can be delivered to a wireless device via Point-to-Point (PTP) and/or Point-To-Multipoint (PTM) mechanisms, and HARQ retransmission/feedback can be applied to both of these mechanisms, as specified in, for example, 3GPP TS 38.300.

FIG. 1 is a diagram of example MBS delivery methods set out in, for example, 3GPP TS 23.247.

For a multicast communication service, shared and individual delivery modes are specified in 3GPP TS 23.247. Between 5GC and NG-RAN, there are two possible delivery methods to transmit the MBS data:
5GC Individual MBS traffic delivery method: This method is only applied for multicast MBS sessions. 5GC receives a single copy of MBS data packets and delivers separate copies of those MBS data packets to individual wireless devices via per-wireless device PDU sessions, hence for each such wireless device one PDU session is required to be associated with a Multicast MBS session. The MBS data received by the MB-user plane function (UPF) is replicated towards the UPF(s) where individual delivery is performed via unicast transport over N19mb interface.
5GC Shared MBS traffic delivery method: This method is applied for both broadcast and multicast MBS sessions. 5GC receives a single copy of MBS data packets and delivers a single copy of those MBS packets to an NG-RAN node, which then delivers the packets to one or multiple wireless devices. These incoming MBS traffic packets are delivered from MB-UPF to NG-RAN node via the N3mb interface.

The 5GC Shared MBS traffic delivery method is required in all MBS deployments. The 5GC Individual MBS traffic delivery method is required to enable mobility when there is an NG-RAN deployment with non-homogeneous support of MBS.

Between the NG-RAN and the wireless device, two delivery methods are available for the transmission of MBS data packets over radio interface:
Point-to-Point (PTP) delivery method: NG-RAN delivers separate copies of MBS data packets over radio interface to individual wireless device(s).
Point-to-Multipoint (PTM) delivery method: NG-RAN delivers a single copy of MBS data packets over radio interface to multiple wireless devices.

NG-RAN may use a combination of PTP/PTM to deliver an MBS data packets to wireless devices.

### MBS Radio Bearer

An MBS Session Resource may be associated with one or more MBS QoS flows, and each of those flows is associated with a QoS profile. Network node provides one or more multicast MBS Radio Bearer (MRB) configurations to the wireless device via RRC signalling, as described in, for example, 3GPP TS 38.300, clause 16.10.3. For a multicast session, the network node may change the MRB type using RRC signalling. For a broadcast session, the network node provides a broadcast MRB with one DL-only RLC-UM entity for PTM transmission, i.e., only one type of an MRB is specified at the moment for the broadcast communication transmission. Network and protocol architectures are described in detail in, for example, 3GPP TS 38.300 chapters 16.10.2 and 16.10.3.

### Group Scheduling and Group Paging

Group scheduling mechanisms for MBS delivery are described in 3GPP standards such as in, for example, 3GPP TS 38.300, clause 16.10.4. RNTI is used for the group transmission where a wireless device can receive different services using the same or different G-RNTI(s)/G-CS-RNTIs, as defined in 3GPP standards such as in, for example, 3GPP TS 38.300. NG-RAN performs certain functions to support MBS. They include management of MBS QoS flows, delivery of MBS data packets from 5GC to multiple wireless devices via PTP or PTM, configuration of wireless device for MBS QoS flow reception at AS layer, controlling switching between PTM and PTP delivery per wireless device, support for multicast session service continuity during Xn and NG handovers, and support for group paging at multicast session activation over radio toward wireless devices in CM-IDLE state and CM-CONNECTED with RRC INACTIVE state.

### MBS Interest Indication

To ensure service continuity of MBS broadcast, the wireless device in RRC_CONNECTED state may send MBS Interest Indication to the network node, consisting of the following information:
1. List of MBS frequencies the wireless device is interested in receiving, sorted in decreasing order of interest
2. Priority between the reception of all listed MBS frequencies and the reception of any unicast bearer
3. List of MBS broadcast services the wireless device is interested in receiving, in case SIB20 is scheduled by the wireless device's PCell.
4. wireless device's priority to MBS broadcast versus unicast reception. MBS Interest Indication information reporting can be implicitly enabled/disabled by the presence of SIB21.

### Mobility Support During MBS Session

Mobility support for service continuation when a wireless device is in an MBS session depends on whether the broadcast or multicast session is taking place, and on whether the source and target network nodes support MBS. For the multicast MBS session, three cases as described: 1) handover from an NG-RAN node (e.g., network node) supporting MBS to a network node not supporting MBS, 2) handover from an NG-RAN node not supporting MBS to a network node supporting MBS, and 3) a handover from a network node supporting MBS to another network node supporting MBS.
In the Multicast MBS case:
   when the handover (HO) takes place from a network node that supports MBS to a network node that does not support MBS, or vice versa, the 5GC Shared MBS Traffic Delivery and 5GC Individual Traffic delivery methods can co-exist temporarily upon handover.
      Mapping information about unicast QoS flows for multicast data transmission and the information of associated multicast QoS flows are provided to an NG-RAN node,
      The delivery method is switched from 5GC Shared MBS Traffic delivery to 5GC Individual MBS delivery via establishing the N3 tunnel of the PDU Session for Individual delivery. SMF realizes that the target node does not support MBS
      GTP tunnel between the UPF and the MB-UPF for 5GC Individual MBS traffic delivery activated by SMF and MBS-SMF
When the HO takes place from a RAN node (e.g., network node) that supports MBS to another network node that also supports MBS, if the shared delivery for the MBS session has not been established towards the target NG-RAN node, it uses MB-SMF (Multicast Broadcast Session Management Function) and MB-UPF (Multicast Broadcast User Place Function) to establish the Shared delivery for the MBS session.
   The PDU Sessions, including the one associated with the MBS Multicast session and used for the 5GC Individual MBS traffic delivery, are handed over to the target ND-RAN node
      Session management function (SMF) triggers the mode switch from the Individual to the Shared delivery mode
      Target node establishes the shared delivery for the MBS Session upon receiving the MBS Session Context
      5GC Individual MBS traffic delivery is terminated by 5GC and changed to the 5GC shared MBS traffic delivery.

### In the Broadcast MBS Case:

The wireless device may receive the same service in the target network node (which supports MBS) if the same MBS session is established with the 5GC Shared MBS traffic delivery.
Currently, a case of when a wireless device is handed over to a network node not supporting the MBS within the broadcast area, is not specified.

### QoE Metrics for MBMS

3GPP standards such as, for example, 3GPP TS 26.346 define QoE metrics for the Multimedia Broadcast Multicast Service (MBMS), in addition to QoE metrics for DASH streaming that can also be used. Table 1 from 3GPP TS 26.346 is provided below.

| | Streaming | Download | |
|---|---|---|---|
| | delivery | delivery | Metric |
| QoE Metric | method | method | type |
| Corruption duration metric | ✓ | | Media |
| Rebuffering duration metric | ✓ | | Session |
| Initial buffering duration metric | ✓ | | Session |
| Successive loss of RTP packets | ✓ | | Media |
| Frame rate deviation | ✓ | | Media |
| Jitter duration | ✓ | | Media |
| Content Access/Switch Time | ✓ | | Session |
| Network Resource | ✓ | ✓ | Session |
| Average codec bitrate | ✓ | | Media |
| Codec information | ✓ | | Media |
| Loss of Objects | | ✓ | Session |
| Distribution of Symbol Count | | ✓ | Session |
| Underrun for Failed Blocks | | | |

### 3GPP Rel-18 QoE Work Item

For 3GPP Rel-18, the RP-221803 describes the Work Item “Enhancement on NR QoE management and optimizations for diverse services” and among others, this work item indicates, the following objectives:
Support for new service type, such as AR, MR, MBS and other new service type defined or to be supported by SA4. Support RAN-visible parameters for the additional service types, and the existing service if needed, and the coordination with SA4 is needed [RAN3, RAN2].
   Specify the new service and the existing service defined or to be supported by SA4, combined with high mobility scenarios, e.g., High Speed Trains.
Specify for QoE measurement configuration and collection in RRC_INACTIVE and RRC_IDLE states for MBS, at least for broadcast service [RAN3, RAN2].
Specify the mechanism to support the alignment of the existing radio related measurement and QoE reporting.
Left-over features from Rel-17, as well as the enhancements of existing features which are not included in Rel-17 normative phase, should be supported in Rel-18 if consensus on benefits are reached [RAN3, RAN2].
   Specify per-slice QoE measurement configuration enhancement.
   Specify RAN visible QoE enhancements for QoE value, RAN visible QoE trigger event, RAN visible QoE Report over F1.
   Specify QoE reporting handling enhancement for overload scenario.

Existing system 3GPP specifications and systems do not specific how to configure QoE measurements or RAN Visible QoE measurements for MBS.

### SUMMARY

Some embodiments advantageously provide methods, systems, and apparatuses for QoE configuration for MBS.

The present disclosure describes one or more embodiments for designing the signaling used for configuring, performing and reporting QoE/RVQoE measurements for MBS.

Unless otherwise stated, the teaches described herein equally apply to both QoE and RVQoE measurements.

In one embodiment, a first network node receives from a second network node (or determines on its own) a QoE configuration for MBS and, within such configuration, or together with it, it receives a first level QoE-configuration item for MBS and second level QoE-configuration items for MBS.

The first level QoEconfiguration item for MBS indicates that MBS is used as one of the following: a service type, a communication service, a delivery service, a service subtype, a subservice type, or just an indication of “MBS”.

A second level QoEconfiguration item for MBS indicates a service type other than MBS (or service subtype or subservice type other than MBS), where the second level QoE-configuration item for MBS is associated to an application matching the indicated service type (or range of applications providing the type of service indicated by the second level QoE configuration item) to be applied to application session(s) whose data is delivered (or can be delivered) via MBS. Examples of service types other than MBS are DASH streaming, Virtual Reality, Mixed Reality, etc.

Also, within the QoE report for MBS or as part of it, an explicit indication is signaled, indicating that MBS is used/can be used/has been used for the delivery of application session's data associated to one or more second level QoE-configuration items for MBS.

According to one aspect of the present disclosure, a network node configured to communicate with a wireless device is provided. The network node is configured to: one of receive from another network node or determine a first level quality of experience, QoE, configuration item for multicast and broadcast service, MBS, and one of receive from the other network node or determine a second level QoE configuration item for the MBS, where the second level QoE configuration is different from the first level QoE configuration item and associated with an application whose data is delivered by the MBS. The network node is configured to indicate, to the wireless device, the first level QoE configuration item and second level QoE configuration item for the wireless device to perform an action based on at least one of the first level QoE configuration item or second level QoE configuration item.

According to one or more embodiments of this aspect, the first level QoE configuration item indicates the MBS is one of: a service type, a communication service, a communication service type, or a delivery method.

According to one or more embodiments of this aspect, the second level QoE configuration item indicates at least one of: a service delivered by the MBS, a session delivered by the MBS, a service type delivered by the MBS, a service subtype delivered by the MBS, or a subservice type delivered by the MBS.

According to one or more embodiments of this aspect, the first level QoE configuration item comprises one of a value or codepoint in at least one of: a service type information element, IE, within an application layer measurement configuration procedure in radio resource control, RRC, signaling, or wireless device application layer measurement configuration IE.

According to one or more embodiments of this aspect, the second level QoE configuration item comprises a set of values indicating a plurality of services types delivered via the MBS for which QoE measurements are requested.

According to one or more embodiments of this aspect, the network node is further configured to indicate at least one of a QoE-related operation or a Radio Access Network visible QoE, RVQoE-related operation for the wireless device to perform, where the at least one of the QoE-related operation or the RVQoE-related operation is associated with the first level QoE configuration item and the second level QoE configuration item, and where the at least one of the QoE-related operation or the RVQoE-related operation comprises one of: performing at least one of QoE measurements or RVQoE measurements for the MBS; reporting of at least one of QoE measurements or RVQoE measurements for the MBS; or performing alignment of at least one of QoE measurements or RVQoE measurements for the MBS with radio related measurements.

According to one or more embodiments of this aspect, the network node is further configured to indicate at least one of a QoE-related operation or a Radio Access Network visible QoE, RVQoE-related operation associated with the first level QoE configuration item and the second level QoE configuration item, where the indication of at least one of the QoE-related operation or the RVQoE-related operation comprises an indication of change in the delivery of data for a service type, the change comprising one of: a change from the MBS to unicast, a change from unicast to the MBS, a change from MBS multicast to unicast, a change from MBS broadcast to unicast, or a change from unicast to MBS broadcast.

According to one or more embodiments of this aspect, the network node is further configured to indicate at least one of a QoE-related operation or a Radio Access Network visible QoE, RVQoE-related operation associated with the first level QoE configuration item and the second level QoE configuration item, where the at least one of the QoE-related operation or the RVQoE-related operation indicates the delivery of the data by the MBS is to be one of: enabled, disabled, continued, discontinued, paused, or resumed.

According to one or more embodiments of this aspect, the network node is further configured to indicate at least one of a QoE-related operation or a Radio Access Network visible QoE, RVQoE-related operation associated with the first level QoE configuration item and the second level QoE configuration item, where the at least one of the QoE-related operation or the RVQoE-related operation is related to mobility of the wireless device one of to or from a second network node, the network node one of supports the MBS or does not support the MBS, and the second network node one of supports the MBS or does not support the MBS.

According to one or more embodiments of this aspect, the indication of at least one of the QoE-related operation or the RVQoE-related operation indicating delivery of the data by one of the MBS or unicast is to be one of: enabled, disabled, continued, discontinued, paused, or resumed.

According to one or more embodiments of this aspect, when the network node and the second network node do not support the MBS, where the indication of at least one of the QoE-related operation or the RVQoE-related operation indicates delivery of the data by the MBS is to be one of: enabled, disabled, continued, discontinued, paused, or resumed.

According to one or more embodiments of this aspect, the network node is further configured to indicate at least one of a QoE-related operation or a Radio Access Network visible QoE, RVQoE-related operation associated with the first level QoE configuration item and the second level QoE configuration item, where the at least one of the QoE-related operation or the RVQoE-related operation is related to mobility of the wireless device one of to or from a second network node, and where the network node and the second network node is configured with one of a same radio access technology, RAT, or a different RAT, and where the indication of at least one of the QoE-related operation or the RVQoE-related operation indicates delivery of the data by the MBS is to be one of: enabled, disabled, continued, discontinued, paused, or resumed.

According to one or more embodiments of this aspect, the network node is further configured to indicate at least one of a QoE-related operation or a Radio Access Network visible QoE, RVQoE-related operation associated with the second level QoE configuration item, where the indication of at least one of the QoE-related operation or the RVQoE-related operation indicates: upon one of: a change from the MBS to unicast; a change from unicast to the MBS; a change from MBS multicast to unicast; a change from MBS broadcast to unicast; a change from unicast to MBS multicast; a change from unicast to MBS broadcast; and where the delivery of the data by the MBS is to be one of: enabled; disabled; continued; discontinued; paused; or resumed.

According to one or more embodiments of this aspect, the action comprises at least one of performing measurements for the MBS or performing measurement for a service type being delivered by the MBS.

According to another aspect of the present disclosure, a method performed by a network node is provided. The network node is configured to communicate with a wireless device. A first level quality of experience, QoE, configuration item for multicast and broadcast service, MBS is one or received from another network node or determined. A second level QoE configuration item for the MBS is one of received from the other network node or determined, where the second level QoE configuration is different from the first level QoE configuration item and associated with an application whose data is delivered by the MBS. The first level QoE configuration item and second level QoE configuration item are indicated to the wireless device for the wireless device to perform an action based on at least one of the first level QoE configuration item or second level QoE configuration item.

According to one or more embodiments of this aspect, the first level QoE configuration item indicates the MBS is one of: a service type, a communication service, a communication service type, or a delivery method.

According to one or more embodiments of this aspect, the second level QoE configuration item indicates at least one of: a service delivered by the MBS, a session delivered by the MBS, a service type delivered by the MBS, a service subtype delivered by the MBS, or a subservice type delivered by the MBS.

According to one or more embodiments of this aspect, the first level QoE configuration item comprises one of a value or codepoint in at least one of: a service type information element, IE, within an application layer measurement configuration procedure in radio resource control, RRC, signaling, or wireless device application layer measurement configuration IE.

According to one or more embodiments of this aspect, the second level QoE configuration item comprises a set of values indicating a plurality of services types delivered via the MBS for which QoE measurements are requested.

According to one or more embodiments of this aspect, at least one of a QoE-related operation or a Radio Access Network visible QoE, RVQoE-related operation are indicated for the wireless device to perform, where the at least one of the QoE-related operation or the RVQoE-related operation is associated with the first level QoE configuration item and the second level QoE configuration item, and where the at least one of the QoE-related operation or the RVQoE-related operation comprises one of: performing at least one of QoE measurements or RVQoE measurements for the MBS, reporting of at least one of QoE measurements or RVQoE measurements for the MBS, or performing alignment of at least one of QoE measurements or RVQoE measurements for the MBS with radio related measurements.

According to one or more embodiments of this aspect, at least one of a QoE-related operation or a Radio Access Network visible QoE, RVQoE-related operation associated with the first level QoE configuration item and the second level QoE configuration item is indicated, where the indication of the at least one of the QoE-related operation or the RVQoE-related operation comprises an indication of change in the delivery of data for a service type, and where the change comprising one of: a change from the MBS to unicast, a change from unicast to the MBS, a change from MBS multicast to unicast, a change from MBS broadcast to unicast, or a change from unicast to MBS broadcast.

According to one or more embodiments of this aspect, at least one of a QoE-related operation or a Radio Access Network visible QoE, RVQoE-related operation associated with the first level QoE configuration item and the second level QoE configuration item is indicated, where the at least one of the QoE-related operation or the RVQoE-related operation indicates the delivery of the data by the MBS is to be one of: enabled; disabled; continued; discontinued; paused; or resumed.

According to one or more embodiments of this aspect, at least one of a QoE-related operation or a Radio Access Network visible QoE, RVQoE-related operation associated with the first level QoE configuration item and the second level QoE configuration item is indicated, where the at least one of the QoE-related operation or the RVQoE-related operation is related to mobility of the wireless device one of to or from a second network node, and where the network node one of supports the MBS or does not support the MBS, and where the second network node one of supports the MBS or does not support the MBS.

According to one or more embodiments of this aspect, the indication of the at least one of the QoE-related operation or the RVQoE-related operation indicating delivery of the data by one of the MBS or unicast is to be one of: enabled; disabled; continued; discontinued; paused; or resumed.

According to one or more embodiments of this aspect, when the network node and the second network node do not support MBS, the indication of the at least one of the QoE-related operation or the RVQoE-related operation indicating delivery of the data by the MBS is to be one of: enabled; disabled; continued; discontinued; paused; or resumed.

According to one or more embodiments of this aspect, at least one of a QoE-related operation or a Radio Access Network visible QoE, RVQoE-related operation associated with the first level QoE configuration item and the second level QoE configuration item is indicated, where the at least one of the QoE-related operation or the RVQoE-related operation is related to mobility of the wireless device one of to or from a second network node, and where the network node and the second network node is configured with one of a same radio access technology, RAT, or a different RAT, and where the indication of the at least one of the QoE-related operation or the RVQoE-related operation indicating delivery of the data by the MBS is to be one of: enabled; disabled; continued; discontinued; paused; or resumed.

According to one or more embodiments of this aspect, at least one of a QoE-related operation or a Radio Access Network visible QoE, RVQoE-related operation associated with the second level QoE configuration item is indicated, where the indication of the at least one of the QoE-related operation or the RVQoE-related operation indicates: upon one of: a change from the MBS to unicast; a change from unicast to the MBS; a change from MBS multicast to unicast; a change from MBS broadcast to unicast; a change from unicast to MBS multicast; a change from unicast to MBS broadcast; and where the delivery of the data by the MBS is to be one of: enabled; disabled; continued; discontinued; paused; or resumed.

According to one or more embodiments of this aspect, the action comprises at least one of performing measurements for the MBS or performing measurement for a service being communicated by the MBS.

According to another aspect of the present disclosure, a wireless device configured to communicate with a network node is provided. The wireless device is configured to: receive an indication of a first level quality of experience, QoE, configuration item for multicast and broadcast service, MBS, and a second level QoE configuration item for the MBS, where the second level QoE configuration is different from the first level QoE configuration item and associated with an application whose data is delivered by the MBS, and perform at least one action based on at least one of the first level QoE configuration item or the second level QoE configuration.

According to one or more embodiments of this aspect, the first level QoE configuration item indicates the MBS is one of: a service type; a communication service; a communication service type; or a delivery method.

According to one or more embodiments of this aspect, the second level QoE configuration item indicates at least one of: a service delivered by the MBS; a session delivered by the MBS; a service type delivered by the MBS; a service subtype delivered by the MBS; or a subservice type delivered by the MBS.

According to one or more embodiments of this aspect, the first level QoE configuration item comprises one of a value or codepoint in at least one of: a service type information element, IE, within an application layer measurement configuration procedure in radio resource control, RRC, signaling, or wireless device application layer measurement configuration IE.

According to one or more embodiments of this aspect, the second level QoE configuration item comprises a set of values indicating a plurality of services types delivered via the MBS for which QoE measurements are requested.

According to one or more embodiments of this aspect, the wireless device is further configured to receive an indication of at least one of a QoE-related operation or a Radio Access Network visible QoE, RVQoE-related operation associated with the first level QoE configuration item and the second level QoE configuration item, where the at least one of the QoE-related operation or the RVQoE-related operation comprises one of: performing at least one of QoE measurements or RVQoE measurements for the MBS; reporting of at least one of QoE measurements or RVQoE measurements for the MBS; or performing alignment of at least one of QoE measurements or RVQoE measurements for the MBS with radio related measurements.

According to one or more embodiments of this aspect, the wireless device is further configured to receive an indication of at least one of a QoE-related operation or a Radio Access Network visible QoE, RVQoE-related operation associated with the first level QoE configuration item and the second level QoE configuration item, where the indication of the at least one of the QoE-related operation or the RVQoE-related operation comprises an indication of change in the delivery of data for a service type, and where the change comprising one of: a change from the MBS to unicast; a change from unicast to the MBS; a change from MBS multicast to unicast; a change from MBS broadcast to unicast; or a change from unicast to MBS broadcast.

According to one or more embodiments of this aspect, the wireless device is further configured to receive an indication of at least one of a QoE-related operation or a Radio Access Network visible QoE, RVQoE-related operation associated with the first level QoE configuration item and the second level QoE configuration item, where the at least one of the QoE-related operation or the RVQoE-related operation indicating the delivery of the data by the MBS is to be one of: enabled; disabled; continued; discontinued; paused; or resumed.

According to one or more embodiments of this aspect, the wireless device is further configured to receive an indication of at least one of a QoE-related operation or a Radio Access Network visible QoE, RVQoE-related operation associated with the first level QoE configuration item and the second level QoE configuration item, where the at least one of the QoE-related operation or the RVQoE-related operation is related to mobility of the wireless device one of to or from a second network node, and where the network node one of supports the MBS or does not support the MBS; and where the second network node one of supports the MBS or does not support the MBS.

According to one or more embodiments of this aspect, the indication of the at least one of the QoE-related operation or the RVQoE-related operation indicating delivery of the data by one of the MBS or unicast is to be one of: enabled; disabled; continued; discontinued; paused; or resumed.

According to one or more embodiments of this aspect, when the network node and the second network node do not support the MBS, where the indication of the at least one of the QoE-related operation or the RVQoE-related operation indicates delivery of the data by the MBS is to be one of: enabled; disabled; continued; discontinued; paused; or resumed.

According to one or more embodiments of this aspect, the wireless device is further configured to receive an indication of at least one of a QoE-related operation or a Radio Access Network visible QoE, RVQoE-related operation associated with the first level QoE configuration item and the second level QoE configuration item, where the at least one of the QoE-related operation or the RVQoE-related operation is related to mobility of the wireless device one of to or from a second network node, and where the network node and the second network node is configured with one of a same radio access technology, RAT, or a different RAT, and where the indication of the at least one of the QoE-related operation or the RVQoE-related operation indicates delivery of the data by the MBS is to be one of: enabled; disabled; continued; discontinued; paused; or resumed.

According to one or more embodiments of this aspect, the wireless device is further configured to receive an indication of at least one of a QoE-related operation or a Radio Access Network visible QoE, RVQoE-related operation associated with the second level QoE configuration item, where the indication of the at least one of the QoE-related operation or the RVQoE-related operation indicates: upon one of: a change from the MBS to unicast; a change from unicast to the MBS; a change from MBS multicast to unicast; a change from MBS broadcast to unicast; a change from unicast to MBS multicast; a change from unicast to MBS broadcast; and where the delivery of the data by the MBS is to be one of: enabled; disabled; continued; discontinued; paused; or resumed.

According to one or more embodiments of this aspect, the action comprises at least one of performing measurements for the MBS or performing measurement for a service type being delivered by the MBS.

According to another aspect of the present disclosure, a method performed by a wireless device is provided. The wireless device is configured to communicate with a network node. An indication of a first level quality of experience, QoE, configuration item for multicast and broadcast service, MBS, and a second level QoE configuration item for the MBS is received, where the second level QoE configuration is different from the first level QoE configuration item and associated with an application whose data is delivered by the MBS. At least one action is performed based on at least one of the first level QoE configuration item or the second level QoE configuration.

According to one or more embodiments of this aspect, the first level QoE configuration item indicates the MBS is one of: a service type; a communication service; a communication service type; or a delivery method.

According to one or more embodiments of this aspect, the second level QoE configuration item indicates at least one of: a service delivered by the MBS; a session delivered by the MBS; a service type delivered by the MBS; a service subtype delivered by the MBS; or a subservice type delivered by the MBS.

According to one or more embodiments of this aspect, the first level QoE configuration item comprises one of a value or codepoint in at least one of: a service type information element, IE, within an application layer measurement configuration procedure in radio resource control, RRC, signaling, or wireless device application layer measurement configuration IE.

According to one or more embodiments of this aspect, the second level QoE configuration item comprises a set of values indicating a plurality of services types delivered via the MBS for which QoE measurements are requested.

According to one or more embodiments of this aspect, an indication of at least one of a QoE-related operation or a Radio Access Network visible QoE, RVQoE-related operation associated with the first level QoE configuration item and the second level QoE configuration item is received, where the at least one of the QoE-related operation or the RVQoE-related operation comprises one of: performing at least one of QoE measurements or RVQoE measurements for the MBS; reporting of at least one of QoE measurements or RVQoE measurements for the MBS; or performing alignment of at least one of QoE measurements or RVQoE measurements for the MBS with radio related measurements.

According to one or more embodiments of this aspect, an indication of at least one of a QoE-related operation or a Radio Access Network visible QoE, RVQoE-related operation associated with the first level QoE configuration item and the second level QoE configuration item is received, where the indication of the at least one of the QoE-related operation or the RVQoE-related operation comprises an indication of change in the delivery of data for a service type, the change comprising one of: a change from the MBS to unicast; a change from unicast to the MBS; a change from MBS multicast to unicast; a change from MBS broadcast to unicast; or a change from unicast to MBS broadcast.

According to one or more embodiments of this aspect, an indication of at least one of a QoE-related operation or a Radio Access Network visible QoE, RVQoE-related operation associated with the first level QoE configuration item and the second level QoE configuration item is received, where the at least one of the QoE-related operation or the RVQoE-related operation indicating the delivery of the data by the MBS is to be one of: enabled; disabled; continued; discontinued; paused; or resumed.

According to one or more embodiments of this aspect, an indication of at least one of a QoE-related operation or a Radio Access Network visible QoE, RVQoE-related operation associated with the first level QoE configuration item and the second level QoE configuration item is received, where the at least one of the QoE-related operation or the RVQoE-related operation is related to mobility of the wireless device one of to or from a second network node, and where the network node one of supports the MBS or does not support the MBS, and where the second network node one of supports the MBS or does not support the MBS.

According to one or more embodiments of this aspect, the indication of the at least one of the QoE-related operation or the RVQoE-related operation indicating delivery of the data by one of the MBS or unicast is to be one of: enabled; disabled; continued; discontinued; paused; or resumed.

According to one or more embodiments of this aspect, when the network node and the second network node do not support the MBS, the indication of the at least one of the QoE-related operation or the RVQoE-related operation indicating delivery of the data the MBS is to be one of: enabled; disabled; continued; discontinued; paused; or resumed.

According to one or more embodiments of this aspect, an indication of at least one of a QoE-related operation or a Radio Access Network visible QoE, RVQoE-related operation associated with the first level QoE configuration item and the second level QoE configuration item is received, where the at least one of the QoE-related operation or the RVQoE-related operation being related to mobility of the wireless device one of to or from a second network node, and where the network node and the second network node is configured with one of a same radio access technology, RAT, or a different RAT; and where the indication of the QoE-related operation indicates delivery of the data by the MBS is to be one of: enabled; disabled; continued; discontinued; paused; or resumed.

According to one or more embodiments of this aspect, an indication of at least one of a QoE-related operation or a Radio Access Network visible QoE, RVQoE-related operation associated with the second level QoE configuration item is received, where the indication of the at least one of the QoE-related operation or the RVQoE-related operation indicating: upon one of: a change from the MBS to unicast; a change from unicast to the MBS; a change from MBS multicast to unicast; a change from MBS broadcast to unicast; a change from unicast to MBS multicast; a change from unicast to MBS broadcast; and where the delivery of the data by the MBS is to be one of: enabled; disabled; continued; discontinued; paused; or resumed.

According to one or more embodiments of this aspect, the action comprises at least one of performing measurements for the MBS or performing measurement for a service being communicated by the MBS.

According to another aspect of the present disclosure, a computer-readable medium comprises instructions which, when executed on at least one processor, cause the at least one processor to perform a wireless device method or network node method, as described herein.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of MBS delivery methods according to 3GPP standards;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a network node according to some embodiments of the present disclosure;

FIG. 9 is another flowchart of an example process in a network node according to some embodiments of the present disclosure;

FIG. 10 is a flowchart of an example process in a wireless device according to some embodiments of the present disclosure; and

FIG. 11 is another flowchart of an example process in a wireless device according to some embodiments of the present disclosure.

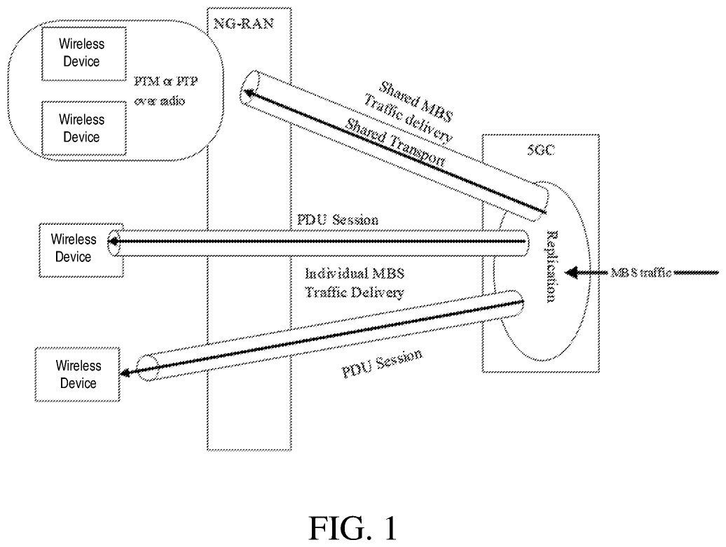

### DETAILED DESCRIPTION

Before describing in detail example embodiments, it is noted that the embodiments reside primarily in combinations of apparatus components and processing steps related to QoE configuration for MBS. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The terms “application layer measurement configuration”, “application measurement configuration”, “QoE measurement configuration”, “QoE configuration”, “QoE measurement and reporting configuration” and “QMC configuration” are used interchangeably. But note that the “QMC configuration file” may not be an equivalent term, and may instead refer to the part of the QoE configuration consisting of an XML file containing instructions of QoE metrics to be collected, etc.

For short notation, where not stated otherwise, the terms “QoE measurement configuration” and “QoE-configuration items” can refer to both QoE (or legacy QoE, or OAM-QoE, whose measurements are not visible to RAN, and RAN Visible QoE.

The terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.

The terms “access stratum” and “radio layer” are used interchangeably when referring to a wireless device.

The terms “service type” and “application layer service type” are used interchangeably.

The term “session” is used herein to refer to either a QoE measurement session or an application session or an application session for which QoE measurement is applied.

The term “session” is used herein to refer to either a QoE measurement session or an application session or an application session for which QoE measurement is applied.

As used herein, “MBS QoE configuration” refers to “QoE configuration for MBS” (e.g. QoE configuration with service type indicating MBS) (i.e., they are considered to be equivalent terms/expressions), and “MBS QoE measurement” refers to “QoE measurement on MBS” (measuring/collecting MBS related QoE metrics) (i.e., they are considered to be equivalent terms/expressions), and “MBS QoE report” refers to “QoE report for MBS” or “QoE report for QoE measurements performed on MBS” (i.e., they are considered to be equivalent terms/expressions). Similarly, “application QoE configuration” refers to “QoE configuration for an/the application” (e.g. QoE configuration with service type indicating the service type of the application) (i.e., they are considered to be equivalent terms/expressions), and “application QoE measurement” refers to “QoE measurement on an/the application” (measuring/collecting QoE metrics associated with the application's service type) (i.e., they are considered to be equivalent terms/expressions), and “application QoE report” refers to “QoE report for an/the application” or “QoE report for QoE measurements performed on an/the application” (i.e., they are considered to be equivalent terms/expressions).

In the remainder of the document Service/service types carried over MBS are indicated in different ways, such as “MTSI-over-MBS”, “MR-over-MBS”, “AR-over-MBS”, “XR-over-MBS”, “public safety and mission critical-over-MBS”, “V2X-over-MBS”, “IPTV-over-MBS”, “IoT-MBS”, “software delivery-over-MBS”, but also using a slightly different wording, such as “MTSI-MBS”, “MR-MBS”, “AR-MBS”, “XR-MBS”, “public safety and mission critical-MBS”, “V2X-MBS”, “IPTV-MBS”, “IoT-MBS”, “software delivery-MBS”. As long as the service/service types are the same, the expressions can be seen as equivalent.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

One or more embodiments described herein applies to UMTS, LTE and NR as well as future RATs such as 6G. Unless otherwise stated, all teachings described herein equally apply to both QoE and RVQoE measurements.

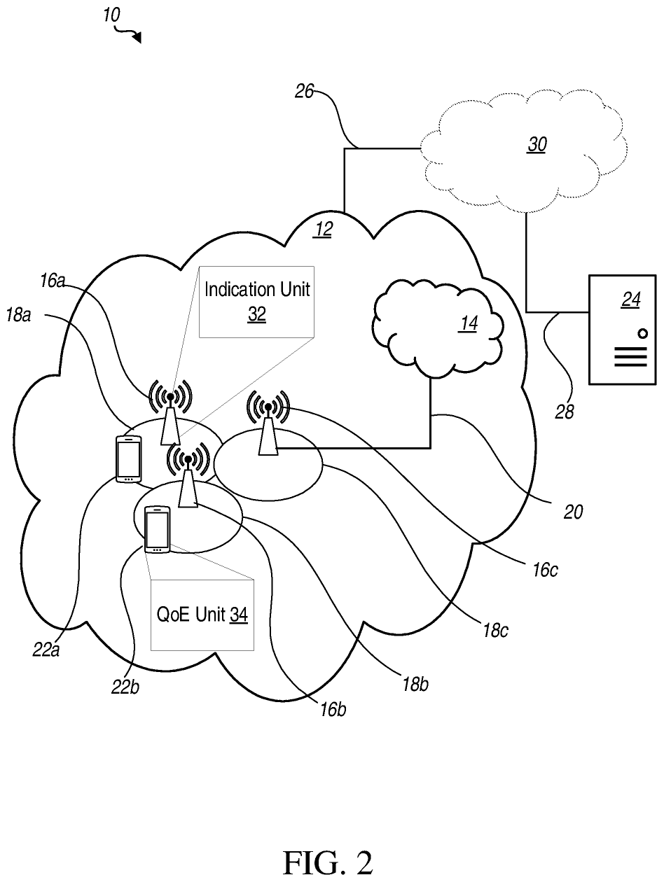

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an indication unit 32 which is configured to perform one or more network node 16 functions described herein such as with respect to QoE configuration for MBS.

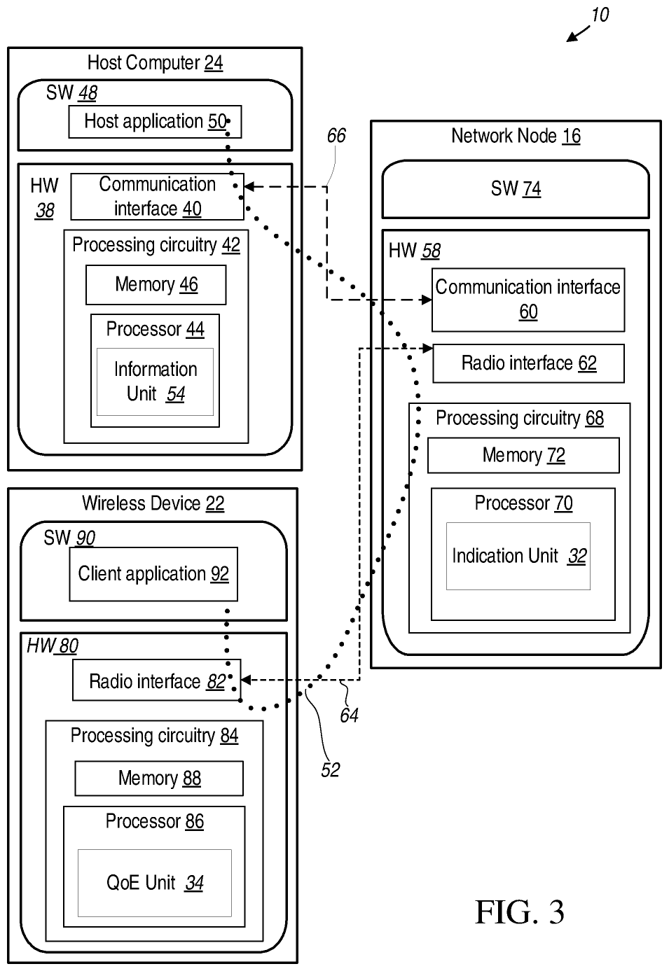

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of process, determine, store, forward, receive, transmit, relay, analyze, etc. information related to QoE configuration for MBS.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include indication unit 32 configured to perform one or more network node 16 functions as described herein such as with respect to QoE configuration for MBS.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a QoE unit 34 configured to perform one or more wireless device 22 functions as described herein such as with respect to QoE configuration for MBS.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as indication unit 32, and QoE unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

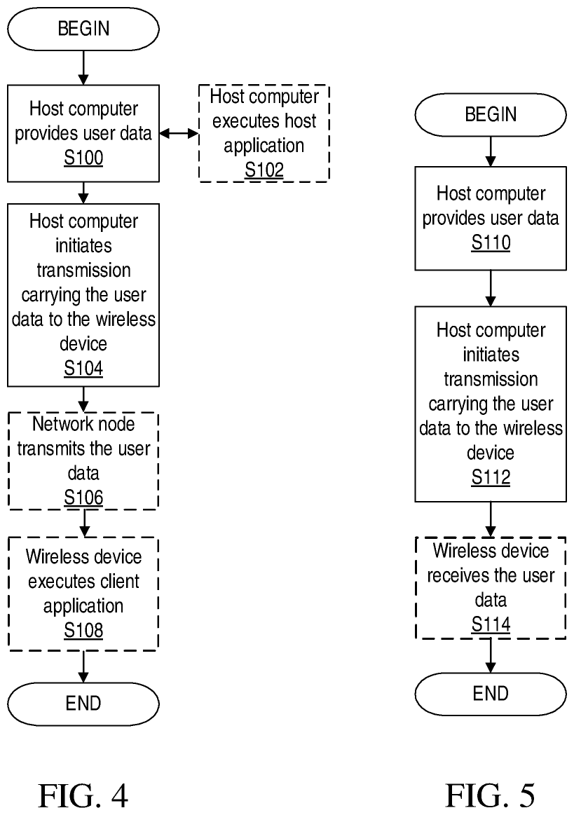

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

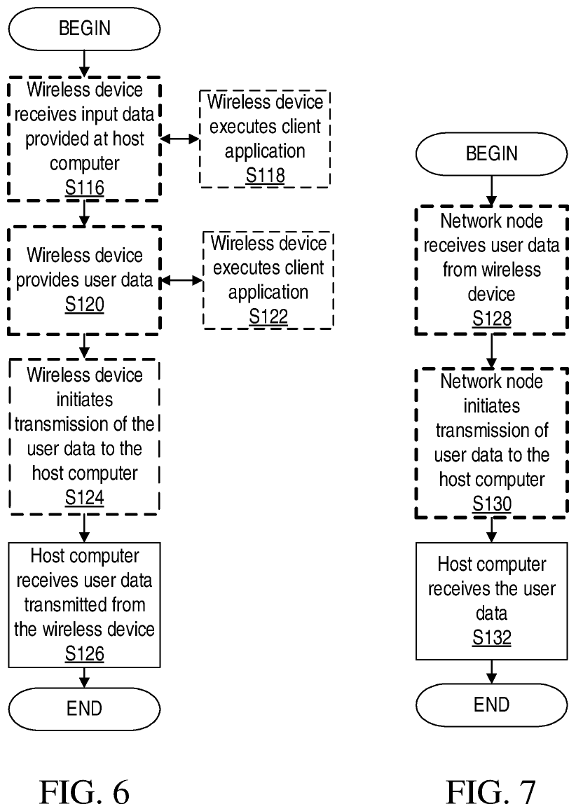

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

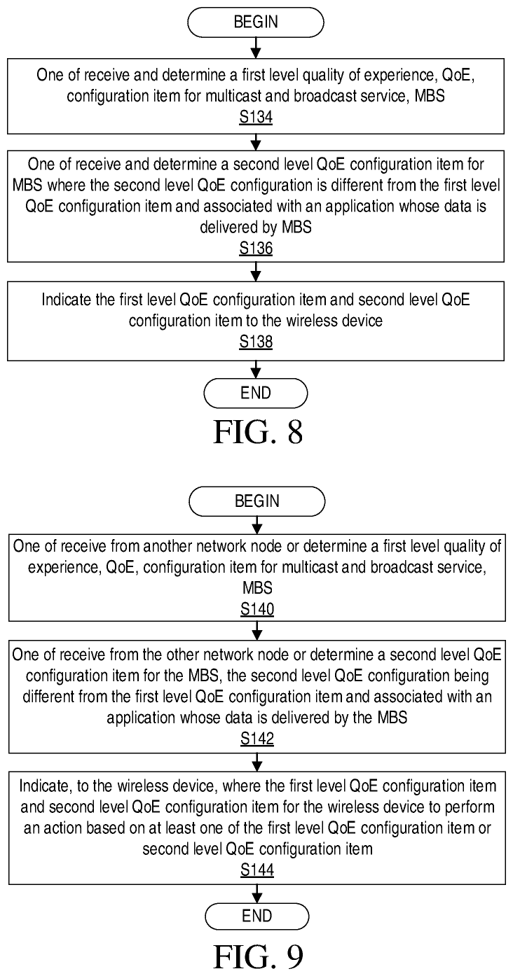

FIG. 8 is a flowchart of an example process in a network node 16 according to some embodiments of the present disclosure. One or more blocks described herein may be performed by one or more elements of network node 16 such as by one or more of processing circuitry 68 (including the indication unit 32), processor 70, radio interface 62 and/or communication interface 60. Network node 16 is configured to one of receive and determine (Block S134) a first level quality of experience, QoE, configuration item for multicast and broadcast service, MBS, as described herein. Network node 16 is configured to one of receive and determine (Block S136) a second level QoE configuration item for MBS where the second level QoE configuration is different from the first level QoE configuration item and associated with an application whose data is delivered by MBS, as described herein. Network node 16 is configured to indicate (Block S138) the first level QoE configuration item and second level QoE configuration item to the wireless device 22, as described herein.

According to one or more embodiments, the first level QoE configuration item indicates at least one of: a service; a service type; a communication service; a communication service type; a delivery service; a delivery method; a delivery type; a service delivery type; a service type delivery; a service type delivery method; a traffic type; a type of delivery method; a service subtype; a subservice type; an indication indicating MBS; an indication of a form of MBS; and an indication of a hybrid delivery type.

According to one or more embodiments, the second level QoE configuration item indicates at least one of: a service; a session; a service type; a service subtype; a subservice type; a service one of in and over MBS; a session one of in and over MBS; a service type one of in and over MBS; a service subtype one of in and over MBS; and a subservice type one of in and over MBS.

According to one or more embodiments, the first level QoE configuration item is a first radio access network, RAN, visible QoE, RVQoE, configuration item and the second level QoE configuration item is a second RVQoE configuration item.

According to one or more embodiments, at least one of the first level QoE configuration item and second level QoE configuration item indicate QoE measurements are configured for MBS for one of a service type and predefined service types.

According to one or more embodiments, the service type and predefined service types include at least one of dynamic adaptive streaming over HTPP, DASH, streaming, a virtual reality and augmented reality.

According to one or more embodiments, the indication of the first level QoE configuration item and second level QoE configuration item to the wireless device includes an indication whether one of MBS, broadcast, MBS broadcast, MBS multicast and unicast has been used to deliver data associated with a session of the application.

FIG. 9 is a flowchart of another example process in a network node 16 according to some embodiments of the present disclosure. One or more blocks described herein may be performed by one or more elements of network node 16 such as by one or more of processing circuitry 68 (including the indication unit 32), processor 70, radio interface 62 and/or communication interface 60. Network node 16 is configured to one of receive from another network node 16 or determine (Block S140) a first level quality of experience, QoE, configuration item for multicast and broadcast service, MBS, as described herein. Network node 16 is configured to one of receive from the other network node 16 or determine (Block S142) a second level QoE configuration item for the MBS, where the second level QoE configuration is different from the first level QoE configuration item and associated with an application whose data is delivered by the MBS, as described herein. Network node 16 is configured to indicate (Block S144), to the wireless device 22, the first level QoE configuration item and second level QoE configuration item for the wireless device 22 to perform an action based on at least one of the first level QoE configuration item or second level QoE configuration item.

According to one or more embodiments, the first level QoE configuration item indicates the MBS is one of: a service type, a communication service, a communication service type, or a delivery method.

According to one or more embodiments, the second level QoE configuration item indicates at least one of: a service delivered by the MBS, a session delivered by the MBS, a service type delivered by the MBS, a service subtype delivered by the MBS, or a subservice type delivered by the MBS.

According to one or more embodiments, the first level QoE configuration item comprises one of a value or codepoint in at least one of: a service type information element, IE, within an application layer measurement configuration procedure in radio resource control, RRC, signaling, or wireless device application layer measurement configuration IE.

According to one or more embodiments, the second level QoE configuration item comprises a set of values indicating a plurality of services types delivered via the MBS for which QoE measurements are requested.

According to one or more embodiments, the network node 16 is further configured to indicate at least one of a QoE-related operation or a Radio Access Network visible QoE, RVQoE-related operation for the wireless device to perform, where the at least one of the QoE-related operation or the RVQoE-related operation is associated with the first level QoE configuration item and the second level QoE configuration item, and the at least one of the QoE-related operation or the RVQoE-related operation comprises one of: performing at least one of QoE measurements or RVQoE measurements for the MBS, reporting of at least one of QoE measurements or RVQoE measurements for the MBS, or performing alignment of at least one of QoE measurements or RVQoE measurements for the MBS with radio related measurements.

According to one or more embodiments, the network node 16 is further configured to indicate at least one of a QoE-related operation or a Radio Access Network visible QoE, RVQoE-related operation associated with the first level QoE configuration item and the second level QoE configuration item, where the indication of at least one of the QoE-related operation or the RVQoE-related operation comprises an indication of change in the delivery of data for a service type, the change comprising one of: a change from the MBS to unicast, a change from unicast to the MBS, a change from MBS multicast to unicast, a change from MBS broadcast to unicast, or a change from unicast to MBS broadcast.

According to one or more embodiments, the network node 16 is further configured to indicate at least one of a QoE-related operation or a Radio Access Network visible QoE, RVQoE-related operation associated with the first level QoE configuration item and the second level QoE configuration item, where the at least one of the QoE-related operation or the RVQoE-related operation indicates the delivery of the data by the MBS is to be one of: enabled, disabled, continued, discontinued, paused, or resumed.

According to one or more embodiments, the network node 16 is further configured to indicate at least one of a QoE-related operation or a Radio Access Network visible QoE, RVQoE-related operation associated with the first level QoE configuration item and the second level QoE configuration item, where the at least one of the QoE-related operation or the RVQoE-related operation is related to mobility of the wireless device one of to or from a second network node 16, and the network node 16 one of supports the MBS or does not support the MBS, and the second network node 16 one of supports the MBS or does not support the MBS.

According to one or more embodiments, the indication of at least one of the QoE-related operation or the RVQoE-related operation indicating delivery of the data by one of the MBS or unicast is to be one of: enabled, disabled, continued, discontinued, paused, or resumed.

According to one or more embodiments, when the network node 16 and the second network node 16 do not support the MBS, the indication of at least one of the QoE-related operation or the RVQoE-related operation indicating delivery of the data by the MBS is to be one of: enabled, disabled, continued, discontinued, paused, or resumed.

According to one or more embodiments, the network node 16 is further configured to indicate at least one of a QoE-related operation or a Radio Access Network visible QoE, RVQoE-related operation associated with the first level QoE configuration item and the second level QoE configuration item, where the at least one of the QoE-related operation or the RVQoE-related operation is related to mobility of the wireless device 22 one of to or from a second network node 16, and the network node 16 and the second network node 16 are configured with one of a same radio access technology, RAT, or a different RAT, and the indication of at least one of the QoE-related operation or the RVQoE-related operation indicates delivery of the data by the MBS is to be one of: enabled, disabled, continued, discontinued, paused, or resumed.

According to one or more embodiments, the network node 16 is further configured to indicate at least one of a QoE-related operation or a Radio Access Network visible QoE, RVQoE-related operation associated with the second level QoE configuration item, where the indication of at least one of the QoE-related operation or the RVQoE-related operation indicates: upon one of: a change from the MBS to unicast, a change from unicast to the MBS, a change from MBS multicast to unicast, a change from MBS broadcast to unicast, a change from unicast to MBS multicast, or a change from unicast to MBS broadcast, and the delivery of the data by the MBS is to be one of: enabled, disabled, continued, discontinued, paused, or resumed.

According to one or more embodiments, the action comprises at least one of performing measurements for the MBS or performing measurement for a service type being delivered by the MBS.

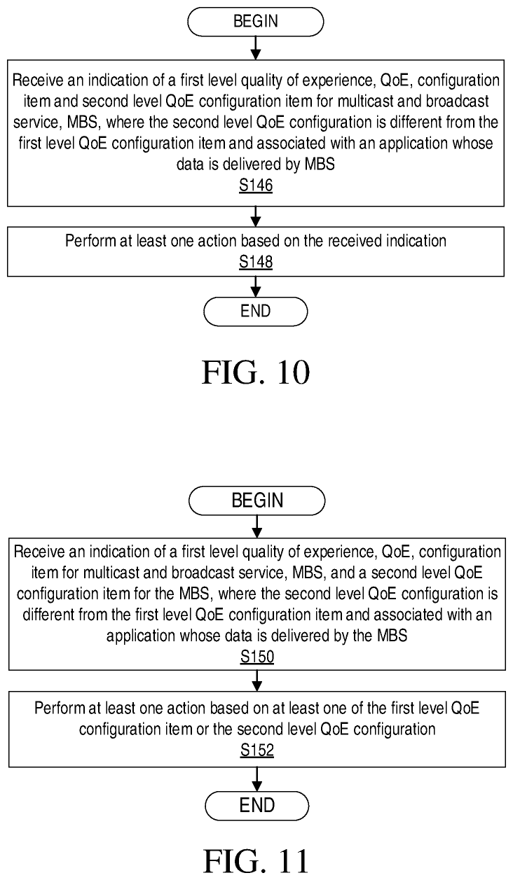

FIG. 10 is a flowchart of an example process in a wireless device 22 according to some embodiments of the present disclosure. One or more blocks described herein may be performed by one or more elements of wireless device 22 such as by one or more of processing circuitry 84 (including the QoE unit 34), processor 86, radio interface 82 and/or communication interface 60. Wireless device 22 is configured to receive (Block S146) an indication of a first level quality of experience, QoE, configuration item and second level QoE configuration item for multicast and broadcast service, MBS, where the second level QoE configuration is different from the first level QoE configuration item and associated with an application whose data is delivered by MBS, as described herein. Wireless device 22 is configured to perform (Block S148) at least one action based on the received indication, as described herein.

According to one or more embodiments, the first level QoE configuration item indicates at least one of: a service; a service type; a communication service; a communication service type; a delivery service; a delivery method; a delivery type; a service delivery type; a service type delivery; a service type delivery method; a traffic type; a type of delivery method; a service subtype; a subservice type; an indication indicating MBS; an indication of a form of MBS; and an indication of a hybrid delivery type.

According to one or more embodiments, the second level QoE configuration item indicates at least one of: a service; a session; a service type; a service subtype; a subservice type; a service one of in and over MBS; a session one of in and over MBS; a service type one of in and over MBS; a service subtype one of in and over MBS; and a subservice type one of in and over MBS.

According to one or more embodiments, the first level QoE configuration item is a first radio access network, RAN, visible QoE, RVQoE, configuration item and the second level QoE configuration item is a second RVQoE configuration item.

According to one or more embodiments, at least one of the first level QoE configuration item and second level QoE configuration item indicate QoE measurements are configured for MBS for one of a service type and predefined service types.

According to one or more embodiments, the service type and predefined service types include at least one of dynamic adaptive streaming over HTPP, DASH, streaming, a virtual reality and augmented reality.

According to one or more embodiments, the indication of the first level QoE configuration item and second level QoE configuration item includes an indication whether one of MBS, broadcast, MBS broadcast, MBS multicast and unicast has been used to deliver data associated with a session of the application.

According to one or more embodiments, the at least one action includes sending a QoE report to the network node, the QoE report indicating one of: timestamps indicating a start time and/or end time for QoE measurements related to application session data delivered via one of MBS, unicast, MBS multicast and MBS broadcast, and whether one of unicast and MBS has been used for delivery of at least a portion of the application session's data.

FIG. 11 is a flowchart of an example process in a wireless device 22 according to some embodiments of the present disclosure. One or more blocks described herein may be performed by one or more elements of wireless device 22 such as by one or more of processing circuitry 84 (including the QoE unit 34), processor 86, radio interface 82 and/or communication interface 60. Wireless device 22 is configured to receive (Block S150) an indication of a first level quality of experience, QoE, configuration item for multicast and broadcast service, MBS, and a second level QoE configuration item for the MBS, where the second level QoE configuration is different from the first level QoE configuration item and associated with an application whose data is delivered by the MBS, as described herein. Wireless device 22 is configured to perform (Block S152) at least one action based on at least one of the first level QoE configuration item or the second level QoE configuration, as described herein.

According to one or more embodiments, the first level QoE configuration item indicates the MBS is one of: a service type, a communication service, a communication service type, or a delivery method.

According to one or more embodiments, the second level QoE configuration item indicates at least one of: a service delivered by the MBS, a session delivered by the MBS, a service type delivered by the MBS, a service subtype delivered by the MBS, or a subservice type delivered by the MBS.

According to one or more embodiments, the first level QoE configuration item comprises one of a value or codepoint in at least one of: a service type information element, IE, within an application layer measurement configuration procedure in radio resource control, RRC, signaling, or wireless device application layer measurement configuration IE.

According to one or more embodiments, the second level QoE configuration item comprises a set of values indicating a plurality of services types delivered via the MBS for which QoE measurements are requested.

According to one or more embodiments, the wireless device 22 is further configured to receive an indication of at least one of a QoE-related operation or a Radio Access Network visible QoE, RVQoE-related operation associated with the first level QoE configuration item and the second level QoE configuration item, where the at least one of the QoE-related operation or the RVQoE-related operation comprises one of: performing at least one of QoE measurements or RVQoE measurements for the MBS, reporting of at least one of QoE measurements or RVQoE measurements for the MBS, or performing alignment of at least one of QoE measurements or RVQoE measurements for the MBS with radio related measurements.

According to one or more embodiments, the wireless device 22 is further configured to receive an indication of at least one of a QoE-related operation or a Radio Access Network visible QoE, RVQoE-related operation associated with the first level QoE configuration item and the second level QoE configuration item, where the indication of the at least one of the QoE-related operation or the RVQoE-related operation comprises an indication of change in the delivery of data for a service type, the change comprising one of: a change from the MBS to unicast, a change from unicast to the MBS, a change from MBS multicast to unicast, a change from MBS broadcast to unicast, or a change from unicast to MBS broadcast.

According to one or more embodiments, the wireless device 22 is further configured to receive an indication of at least one of a QoE-related operation or a Radio Access Network visible QoE, RVQoE-related operation associated with the first level QoE configuration item and the second level QoE configuration item, where the at least one of the QoE-related operation or the RVQoE-related operation indicates the delivery of the data by the MBS is to be one of: enabled, disabled, continued, discontinued, paused, or resumed.

According to one or more embodiments, the wireless device 22 is further configured to receive an indication of at least one of a QoE-related operation or a Radio Access Network visible QoE, RVQoE-related operation associated with the first level QoE configuration item and the second level QoE configuration item, where the at least one of the QoE-related operation or the RVQoE-related operation is related to mobility of the wireless device 22 one of to or from a second network node, the network node 16 one of supports the MBS or does not support the MBS, and the second network node 16 one of supports the MBS or does not support the MBS.

According to one or more embodiments, the indication of the at least one of the QoE-related operation or the RVQoE-related operation indicating delivery of the data by one of the MBS or unicast is to be one of: enabled, disabled, continued, discontinued, paused, or resumed.

According to one or more embodiments, when the network node 16 and the second network node 16 do not support the MBS, the indication of the at least one of the QoE-related operation or the RVQoE-related operation indicating delivery of the data by the MBS is to be one of: enabled, disabled, continued, discontinued, paused, or resumed.

According to one or more embodiments, the wireless device 22 is further configured to receive an indication of at least one of a QoE-related operation or a Radio Access Network visible QoE, RVQoE-related operation associated with the first level QoE configuration item and the second level QoE configuration item, the at least one of the QoE-related operation or the RVQoE-related operation being related to mobility of the wireless device 22 one of to or from a second network node 16, and where the network node 16 and the second network node 16 is configured with one of a same radio access technology, RAT, or a different RAT, and where the indication of the at least one of the QoE-related operation or the RVQoE-related operation indicating delivery of the data by the MBS is to be one of: enabled, disabled, continued, discontinued, paused, or resumed.

According to one or more embodiments, the wireless device 22 is further configured to receive an indication of at least one of a QoE-related operation or a Radio Access Network visible QoE, RVQoE-related operation associated with the second level QoE configuration item, where the indication of the at least one of the QoE-related operation or the RVQoE-related operation indicates: upon one of: a change from the MBS to unicast, a change from unicast to the MBS, a change from MBS multicast to unicast, a change from MBS broadcast to unicast, a change from unicast to MBS multicast, a change from unicast to MBS broadcast, and where the delivery of the data by the MBS is to be one of: enabled, disabled, continued, discontinued, paused, or resumed.

According to one or more embodiments, the action comprises at least one of performing measurements for the MBS or performing measurement for a service type being delivered by the MBS.

Having described the general process flow of arrangements of the disclosure and having provided examples of hardware and software arrangements for implementing the processes and functions of the disclosure, the sections below provide details and examples of arrangements for QoE configuration for MBS.

Some embodiments provide QoE configuration for MBS. One or more wireless device 22 functions described below may be performed by one or more of processing circuitry 84, processor 86, QoE unit 34, radio interface 82, etc. One or more network node 16 functions described below may be performed by one or more of processing circuitry 68, processor 70, indication unit 32, radio interface 62, etc.

### A First Variant

In a first variant, the MBS related QoE measurements are configured in a separate QoE configuration, e.g., with MBS indicated as the service type. As other QoE configurations, this MBS QoE configuration is created by an entity in the OAM system or another, possibly administrational, entity, typically external to the RAN and CN, and then conveyed to the RAN (directly for management-based QoE configurations and via the CN for signaling-based QoE configurations), and then the RAN forwards the QoE configuration to one or more wireless devices.

In one scenario/example of this variant, the OAM system (or another entity) also creates a QoE configuration for at least one service type which may be carried via MBS (e.g. streaming) and this (these) QoE configuration(s) is (are) also conveyed to the RAN and forwarded to one or more wireless devices 22, so that a wireless device 22 that has received the MBS QoE configuration also has received a QoE configuration for at least one service type that can be carried via MBS. In the wireless device 22, both these QoE configurations are delivered to the wireless device 22's application layer. For the purpose of explanation, two such service types are assumed in an explanatory example, hereinafter denoted as “service type A” and “service type B”. An example wireless device 22 has thus received one MBS QoE configuration (e.g., for service type MBS), one QoE configuration for service type A and one QoE configuration for service type B, all of which have been received by the UE AS (e.g., wireless device AS) and forwarded the wireless device 22's application layer. In one variant, rather than having a dedicated configuration for a service type (e.g., configuration for service type A), a configuration may apply to several service types.

Subsequently, when an application of service type A or service type B starts a session with data carried over MBS, and, if, for the sake of the example assume that the application is of service type A, the QoE configuration is merged with, or made a complement of, the QoE configuration associated with service type A. To support this, the wireless device 22 application layer may implement some level of coordination of QoE configurations stored in the wireless device 22 application layer, e.g., handled by a central entity and/or making use of wireless device 22 application layer internal notifications, signaling or messaging. Alternatively, this merger or complementing of the QoE configurations may be made even before any application session is started, e.g., as soon as the wireless device 22 application layer has received (together or one at a time) both an MBS QoE configuration and a QoE configuration for a service type which can have session data carried by MBS.

In one variant, the network node 16 may configure the wireless device 22 with the merging and/or complementing rules for the two configurations. For example, in case the two configurations have different settings for a configuration parameter, the network node 16 may indicate whether the setting from the MBS configuration or the service type configuration has precedence. Alternatively, the wireless device 22 may decide on its own how to merge and/or mutually complement the two configurations. In any case, the result would be that when the application session whose data is carried by MBS starts, the wireless device 22 would perform the QoE measurements in parallel on the MBS session and on the application session. In this context, the MBS session, as seen from the QoE measurement point of view, would coincide with the application session, even if MBS may be broadcasting or multicasting data both before and after the duration of the application session.

The MBS related QoE metrics measured/collected in accordance with the MBS QoE configuration could then be integrated in the QoE report(s) containing the service type A QoE metrics measured/collected on/from the application session in accordance with the QoE configuration for service type A. Alternatively, the measured/collected MBS QoE metrics could be sent in QoE report(s) which are separated from the QoE report(s) associated with the application session and the QoE configuration for service type A. In the latter case, a QoE report for MBS (created in accordance with the QoE configuration for MBS) and a QoE report for the application (created in accordance with the QoE configuration for service type A) could advantageously be sent to the RAN in the same RRC message, e.g., the same MeasurementReportAppLayer message, but one message per QoE report could also be used. Similarly, such a pair of MBS QoE report and service type A QoE report could advantageously be sent from the wireless device 22's application layer to the UE AS in the same AT command (or unsolicited result code), e.g., in a +CAPPLEVMRNR command, but one AT command (or one unsolicited result code), e.g., one +CAPPLEVMRNR command, for each QoE report could also be used.

In another scenario/example, the network node 16 sends a QoE configuration for MBS to a wireless device 22 and the MBS QoE configuration is conveyed to and stored at the wireless device 22 application layer, while the wireless device 22 has no QoE configuration(s) for any service type or application that may start a session with data carried via MBS. If in this situation, an application in the wireless device 22 starts a session with data carried by MBS, the QoE measurements could be initiated for MBS (in accordance with the QoE configuration for MBS) and these MBS QoE measurements could continue until the application session ends. Alternatively, if one or more application sessions pertaining to other service types are started while the aforementioned session is still ongoing, the MBS QoE measurements may proceed until the last session ends. The measured/collected MBS related QoE metrics would be sent to the RAN in one or more QoE report(s) containing only measured/collected MBS related QoE metrics without any measured/collected QoE metrics associated with the application session.

Alternatively, no QoE measurements will be initiated in this scenario, and the QoE configuration for MBS will be kept in store in the wireless device 22's application layer, waiting for a possible QoE configuration for a service type which can have session data carried by MBS (which could trigger MBS QoE measurements by starting a session of an application of that service type). With that alternative, MBS QoE measurements could thus only be performed if parallel QoE measurements are performed on an application session with data carried by MBS.

Optionally, the network node 16 could configure the wireless device 22 to perform in either of these ways with regards to the possible execution of MBS QoE measurements, i.e., whether MBS QoE measurements may or may not be performed without parallel QoE measurements on an application session with data carried by MBS. Such a configuration could be provided to the wireless device 22, e.g., in the MBS QoE configuration, or in an RRC message carrying the MBS QoE configuration to the wireless device 22 (e.g., an RRCReconfiguration message containing an AppLayerMeasConfig-r17 IE with an MBS QoE configuration), or in an RRC message without any MBS QoE configuration (e.g., an RRCReconfiguration message containing an AppLayerMeasConfig-r17 IE without any MBS QoE configuration).

In the above description of one of the variants described herein, only QoE configurations and measurements have been considered, but the same variant can be applied also for RVQoE configurations and measurements (where the RVQoE configuration is created by the RAN (e.g., network node (a gNB or an eNB), i.e., not by an OAM entity or any other RAN external entity as in the case of QoE configurations). An RVQoE configuration for MBS (e.g., with the service type indicating MBS) may be merged with, or made to complement, an RVQoE configuration for a service type (or an application) whose session data may be carried by MBS. Optionally, an RVQoE configuration for MBS may also complement a QoE configuration for a service type whose session data may be carried by MBS (even if there is no RVQoE configuration for that service type).

As described above for QoE configurations, as one alternative, MBS RVQoE measurements may be started also when an application session without an associated QoE configuration starts a session with data carried by MBS, or, as another alternative, may not be started in this situation, but only when there are QoE measurements being performed on the application session whose data is carried by MBS. And, again as described above for the case of QoE configurations, the choice between these two wireless device 22 behaviors may be configured by the network node 16, e.g., in an AppLayerMeasConfig-r17 IE in an RRCReconfiguration message, e.g., together with the MBS QoE configuration (i.e., in the same AppLayerMeasConfig-r17 IE). Regarding the RVQoE report(s) for the MBS session and the application session, the same applies as described above for the QoE report(s), i.e., the measured/collected RVQoE metrics may be reported in the same RVQoE report(s) as the measured/collected RVQoE metrics for the application session, or in separate RVQoE report(s) (e.g., sent to the RAN in the same RRC message, e.g., in the same MeasurementReportAppLayer message).

### A Second Main Solution Variant

In another variant, the MBS QoE measurement configuration includes indication(s) of the one or more service types which may be carried by MBS and for which the network node 16 is interested in receiving QoE measurement results. To support this, the QoE configuration concept (in general or only for MBS QoE measurements) may be extended with the possibility to include indications of multiple service types in one measurement configuration IE.

The MBS QoE measurement configuration would then be “distributed” to each application at the application layer that matches one of the indicated service type(s). To support this distribution, the wireless device 22 application layer may implement some level of coordination of QoE configurations stored in the wireless device 22 application layer, and/or coordination of QoE configuration/measurement related application layer internal signaling/messaging, e.g., handled by a central entity and/or making use of wireless device 22 application layer internal notifications, signaling or messaging.

When the MBS QoE configuration has been distributed to the affected applications, this variant can work as the first variant above, i.e., the MBS QoE configuration could for instance be merged with, or made a complement of, a QoE configuration for each application, or possibly be treated as a “stand-alone” MBS QoE configuration, e.g., in case there is no QoE configuration associated with the application. Similar to the first variant, the network node 16 may indicate to the wireless device 22 the merging and/or complementing rules, or the wireless device 22 may decide on its own.

### A Third Variant

In another (third) variant, which is related to the second variant above, the service type indicated in the MBS QoE configuration is “MBS” (or similar), while the service type(s) of the application(s) whose session data may be carried by MBS is (are) indicated as subservice type(s) or service subtype(s). As another option, the service types of applications whose session data may be carried by MBS may be indicated separately as the service type(s) for which session data may be carried by MBS (e.g., instead of indicating this (these) service type(s) as subservice type(s) or service subtype(s).

As an example, the service type indicated in the MBS QoE configuration could be “MBS” (or similar), while “streaming” (e.g., DASH streaming) and “VR” could be indicated as subservice types for applications whose session data may be carried by MBS.

In addition, to aid the analysis of MBS QoE reports and corresponding application QoE reports (e.g., in the MCE or another QoE report consumer), it could be indicated in a QoE report whether the report pertains to an application session of a service type which may be regarded as a subservice type (or service subtype) of MBS, e.g., if the application session's data is carried by MBS, or if the application session's data is carried by MBS and there is a QoE configuration for MBS in the wireless device. This feature may be particularly useful in view of mobility (e.g., handover), where MBS data delivery (e.g., MBS Multicast delivery) may be changed to unicast data delivery (and vice versa) in conjunction with mobility between two cells. Following the scheme above, application (and the content of QoE report(s)) may be regarded as a “subservice type associated with MBS” while the application session's data is delivered through MBS Multicast, but would be regarded as a “service type” while the application session's data is delivered via unicast.

This could, for example, be supported by the following service type/service subtype indications in concerned signaling, e.g., NGAP (e.g., for signaling-based QoE configuration), signaling between the OAM system (or other creators of QoE configurations and/or or consumers of QoE reports) and the RAN (e.g., network node 16 (a gNB or an eNB)), and/or RRC signaling between the RAN and the wireless device 22:
Service type: “MBS”
Service subtype indication for MBS: “TRUE” (or “FALSE”)
(If the service subtype indication for MBS is set to “TRUE”:) Service subtypes for MBS: “streaming”, “VR” . . . .

### Or:

Service type: “MBS”

(Optional:) Service subtypes for MBS: “streaming”, “VR” . . . .

In a variant, specific service types may be defined for the service when MBS is used. As an example, currently there are service types “streaming”, “MTSI” and “VR”. New service types “streaming-MBS”, “MTSI-MBS”, “MR-MBS”, “AR-MBS”, “XR-MBS”, “public safety and mission critical-MBS”, “V2X-MBS”, “IPTV-MBS”, “IoT-MBS”, “software delivery-MBS” and “VR-MBS” may be defined. New codepoints correspond to different MBS variants such as e.g., MBS Multicast, MBS Broadcast, MBS PTM, or MBS PTP, as a standalone IE, i.e., or in combination with different service types, e.g., “streaming-MBS Broadcast”, or separately from the service types, as a standalone IE.

### A Fourth Variant

In another (fourth) variant, the MBS QoE measurement configuration includes the full configuration of the QoE measurements for the case when MBS is used. That means that when MBS is indicated by some means, e.g., as a service type, a communication service, a delivery service, a service delivery type, a service type delivery, a service type delivery method, a service subtype, a subservice type, or just a simple indication of “MBS”, only that configuration should be applied by the wireless device 22. Even if the wireless device 22 has been configured with QoE measurements for the same service types, these should not be applied when MBS is used as the communication service, but only the QoE configuration for MBS. This behavior could, e.g., be described in the procedure text in RRC or in another specification. This may mean that the same or similar configuration may be signaled to the wireless device 22, both in the QoE configuration for MBS and in the QoE configuration used in other cases than for MBS, as the same service type, e.g., DASH steaming, may be used both when MBS is used and when MBS is not used. The different QoE configurations may be identified by different identities, such as, e.g., the measConfigAppLayerId, QoE reference or some other identity.

An example of such configurations may, e.g., be:

QoE configuration 1: measConfigAppLayerId=1, service type=streaming, QoE configuration parameters, no MBS indication or alternatively MBS indicated not to be used.

QoE configuration 2: measConfigAppLayerId=2, service type=MTSI, QoE configuration parameters, no MBS indication or alternatively MBS indicated not to be used.

QoE configuration 3: measConfigAppLayerId=3, service type=streaming, QoE configuration parameters, indication of MBS.

The wireless device 22 will in this case collect measurements according to QoE configuration 1 when streaming service is used and no MBS is used. The wireless device 22 will collect measurements according to QoE configuration 3 when streaming service is used and MBS is the communication service. The QoE configurations may contain configuration parameters that are the same in both configurations

### A Fifth Variant

In another (fifth) variant, the MBS is seen as a type of service delivery (or a service type delivery, or a service type delivery method) and the QoE configuration contains an indication (or the RVQoE configuration contains an indication) that results in configuring the wireless device 22's Application Layer or the UE Access Stratum to report, together with or as part of a QoE report or together with or as part of a RVQoE report, an indication of one or more service type delivery (or of service type delivery methods), used for the delivery to the wireless device 22 of at least part of the data to which the QoE/RVQoE report pertains to.

### Some Examples Detailed Embodiments in Terms of Methods for Wireless Devices 22 and Network Nodes 16

### Example Embodiments for Network Nodes 16

A first network node 16 (e.g., a first RAN node) receives from a second network node 16 (e.g., a second RAN node, or an OAM node, or a CN node), or determines by itself, a QoE/RVQoE configuration for Multicast Broadcast Service (MBS), which the first network node 16 subsequently sends/forwards to one or more wireless device(s) 22.

In a first embodiment, first example, a first network node 16 (e.g., a first RAN node) receives/determines, as part of a QoE/RVQoE configuration for MBS, or together with a QoE/RVQoE configuration for MBS:
a first level QoE configuration item for MBS, where the first level QoE configuration item (or RVQoE configuration item) for MBS indicates MBS (or Broadcast, or Multicast, or MBS Broadcast, or MBS Multicast) as one or more of:
   a service
   a service type.
   a communication service
   a communication service type
   a delivery service
   a delivery method
   a delivery type
   a service delivery type
   a service type delivery
   a service type delivery method
   a traffic type
   a type of delivery method
   a service subtype
   a subservice type
   an indication indicating “MBS”
   an indication of a form of MBS (e.g., delivery mode, such as MBS Multicast, MBS Broadcast, MBS PTM, or MBS PTP)
   An indication of a hybrid delivery type (in this case MBS Multicast or MBS Broadcast can be indicated as a service delivery subtype):
      “VR-over-MBS” in the case where VR is delivered over either of MBS services
      “DASH-over-MBS” in the case where DASH is delivered over either of the MBS services
      “MTSI-over-MBS” in the case where MTSI is delivered over either of the MBS services
      Similar can be done for “MR-over-MBS”, “AR-over-MBS”, “XR-over-MBS”, “public safety and mission critical-over-MBS”, “V2X-over-MBS”, “IPTV-over-MBS”, “IoT-MBS”, “software delivery-over-MBS”
         where the first level QoE configuration item (or RVQoE configuration item) may refer to MBS in general or one of the possible forms of MBS, such as MBS Multicast, MBS Broadcast, MBS PTM, or MBS PTP and
one or more second level QoE configuration item(s) (or RVQoE configuration item(s)) for MBS, wherein a second level QoE configuration item (or RVQoE configuration item) for MBS indicates one or more of the following:
   a service
   a session
   a service type
   a service subtype
   a subservice type
   a service in/over MBS
   a session in/over MBS
   a service type in/over MBS
   a service subtype in/over MBS
   a subservice type in/over MBS
      where a second level QoE configuration item (or second level RVQoE configuration item) for MBS is associated with an application matching the indicated service type (or range of applications providing the type of service indicated by the second level QoE configuration item (or second level RVQoE configuration item)) associated to application session(s) whose data is delivered (or can be delivered) via MBS.

According to one or more embodiments, the QoE configuration can indicate that QoE measurements are configured for MBS as a service type (or any of the options listed above) and within the “MBS” umbrella term, one or more second level items are included (e.g., one or more service types).

In a second example, the order between the first level QoE configuration item (or first level RVQoE configuration item) and the second level QoE configuration items (or second level RVQoE configuration item) are inverted.

According to this second example, the QoE configuration can indicate that QoE measurements are configured for certain service types (e.g. DASH Streaming or VR) and, as second level, it indicates MBS (or one of its variants such as Multicast, Broadcast, MBS Multicast, MBS Broadcast) as a service type (or as a service type delivery, a service type delivery method, or any other options listed above), is used/can be used for the delivery of data concerning the service type(s).

In a first example of implementation:
the first level QoE configuration item for MBS is a new value (codepoint) added to the Service Type IE within the appLayerMeasConfig in RRC and the wireless device Application Layer Measurement Configuration Information IE in NGAP (e.g., 3GPP TS 38.413); for example, the new value (codepoint) can be “MBS”, or “MBS Broadcast” or “MBS Multicast”, or “MBS PTM” or “MBS PTP” and
the one or more second level QoE configuration item(s) for MBS are elements of a new IE (e.g., encoded as a SEQUENCE in ASN.1) extending the appLayerMeasConfig in RRC and the wireless device Application Layer Measurement Configuration Information IE in NGAP and comprising a set of values indicating a list of service types for which application session's data is carried over MBS and for which QoE measurements are requested (for example: “QMC for DASH streaming”, “QMC for MTSI”, “QMC for VR”, or “DASH streaming”, “MTSI”, “VR”).

In another embodiment, together with or as part of the QoE configuration (or RVQoE configuration) pertaining to MBS, an indication is signaled (e.g., a flag, encoded as a BOOLEAN, or as an ENUMERATED in ASN.1), to configure a wireless device 22 to report together with or within a QoE or RVQoE report whether MBS or Broadcast, or Multicast, or MBS Broadcast, or MBS Multicast, or Unicast has been used for the delivery of data associated with a session of an application, where, in the first variant of the first embodiment, the application is associated to (e.g. matching or indicated by) one or more second level QoE configuration item for MBS, or, according to the second variant of the first embodiment, the application is associated to (e.g. matching or indicated by) one or more first level QoE configuration item for MBS.
In one variant, this indication can be used to configure a wireless device 22 to send QoE/RVQoE report(s) only when MBS is used, or only when unicast is used, or when a portion of the application session's data which the QoE/RVQoE refers to is delivered via MBS and another portion is delivered via Unicast.
   In a subvariant, the indication of MBS as a condition for sending of QoE/RVQoE report(s) may be further refined to indicate a certain form of MBS, or a group of forms of MBS, such as MBS Broadcast, MBS Multicast, MBS PTM and/or MBS PTP.
In another variant, this indication can be used to configure a wireless device 22 to report together with or within the QoE/RVQoE report a value to signal which type of delivery or which service delivery type/service type delivery has been used, such as “MBS”, “Unicast”, “only MBS”, “only Unicast”, “MBS and Unicast”, “first MBS, then Unicast”, “first Unicast, then MBS”, “first MBS, then Unicast, then MBS”, “first Unicast, then MBS, then Unicast”.
   As one option, the type of delivery or the service delivery type/service type delivery may also be a list of delivery types in the chronological order in which they occurred (note that the same delivery type or the service delivery type/service type delivery can be included more than once in the list, if the wireless device 22 switches back and forth between delivery types or between service delivery types or between service type delivery).
      As a sub-option, the list may include a timestamp for each switch of delivery type or for each switch of service delivery type or for each switch of service type delivery.
      As another sub-option, the list may include a duration of each listed delivery type/service delivery type/service type delivery.
      As another sub-option, the list may include a data amount delivered for each listed delivery type/service delivery type/service type delivery.
   As another option, the indication of the type of delivery/service delivery type/service type delivery may include the total duration spent with each delivery type/service delivery type/service type delivery. Such a total duration may be the sum of the durations of multiple periods of the same delivery type/service delivery type/service type delivery.
   As another option, which may be combined with the preceding option, the indication of the type of delivery/service delivery type/service type delivery may include the total amount of data delivered using each delivery type/service delivery type/service type delivery. Such a total amount of data may be the sum of the amount of data delivered during multiple periods of the same delivery type/service delivery type/service type delivery.
   In one option the identity identifying the QoE configuration, e.g., the measConfigAppLayerId or QoE reference or another identity, may be used to identify that MBS or an MBS variant was used as delivery method/delivery type/service delivery type/service type delivery. If the network node 16 indicated MBS or an MBS variant in the QoE configuration, the network node 16 may store the information that the specific QoE configuration relates to an MBS delivery method/delivery type/service delivery type/service type delivery, and when the wireless device 22 sends a QoE report the network node 16 may map the identity towards the delivery method/delivery type/service delivery type/service type delivery such as MBS or an MBS variant.
In one variant, which may be combined with either of the above variants, the wireless device 22 may also include in the QoE/RVQoE report, QoE/RVQoE metrics related to a second level QoE/RVQoE configuration item, e.g., QoE/RVQoE metrics related to the application associated with the second level QoE/RVQoE configuration item.

In a second example of implementation, capturing a possible combination of the previous embodiments:
the first level QoE configuration item for MBS is a new value (codepoint) added to the Service Type IE within the appLayerMeasConfig in RRC and the UE Application Layer Measurement Configuration Information IE in NGAP (e.g., 3GPP TS 38.413); for example, the new value (codepoint) can be “MBS”, or “MBS Broadcast” or “MBS Multicast”, or “MBS PTM” or “MBS PTP”
   and
the one or more second level QoE configuration item(s) for MBS are elements of a new IE (e.g., encoded as a SEQUENCE in ASN.1) extending the appLayerMeasConfig in RRC and the UE Application Layer Measurement Configuration Information IE in NGAP and comprising a set of values indicating a list of service types (or service subtypes, or subservice types) carried over MBS and for which QoE measurements are requested (for example: “QMC for DASH streaming”, “QMC for MTSI”, “QMC for VR”, or “DASH streaming”, “MTSI”, “VR”)
   and
together with, or as part of, the first configuration item, or together with, or as part of, at least one of the one or more second configuration item(s), an indication (e.g., a flag encoded as a BOOLEAN or as an ENUMERATED in ASN.1) is signaled, configuring the wireless device 22 to include an indication in the QoE report indicating the type of delivery/service delivery type/service type delivery that has been used for the delivery of the application session data associated with the one or more second level QoE-configuration item for MBS, e.g., that MBS has been used or that MBS Broadcast has been used or indicating multiple delivery types/service delivery types/service type deliveries that have been used, e.g. in the form of a chronologically ordered list (with any of the above described options).

In another embodiment, together with or as part of a QoE configuration (or RVQoE configuration) pertaining to MBS, or separately from the QoE configuration, a network node 16 can receive from another network node 16 or send to a wireless device 22 one or more indications concerning QoE-related (and/or RVQoE-related) operation(s) for MBS,

where a QoE-related (and/or RVQoE-related) operation for MBS is one of:
1) performing QoE/RVQoE measurements for MBS,
2) reporting of QoE/RVQoE measurements for MBS,
3) alignment/correlation of QoE/RVQoE measurement for MBS with radio related measurements,
4) reporting together with or as part of QoE/RVQoE report indication of change(s) in the way data for a service type is delivered, i.e., one of:
   change from MBS to Unicast change from Unicast to MBS
   any change between MBS and Unicast and vice versa
   change from MBS Multicast to Unicast
   change from MBS Broadcast to Unicast
   change from Unicast to MBS Multicast
   change from Unicast to MBS Broadcast
   change from MBS Multicast using PTM to Unicast
   change from MBS Multicast using PTP to Unicast
   change from Unicast to MBS Multicast using PTM
   change from Unicast to MBS Multicast using PTP
   any change between MBS delivery modes,
   change from MBS Multicast to MBS Broadcast,
   change from MBS Broadcast to MBS Multicast,
   change from MBS Broadcast to MBS Multicast using PTM,
   change from MBS Broadcast to MBS Multicast using PTP,
   change from MBS Multicast using PTM to MBS Broadcast,
   change from MBS Multicast using PTP to MBS Broadcast,
   change from MBS Multicast using PTM to MBS Multicast using PTP,
   change from MBS Multicast using PTP to MBS Multicast using PTM
      and indications concerning QoE-related (and/or RVQoE-related) operations for MBS can be one or more of:
an indication, for any, or for each, or for all of the second level QoE configuration item(s) (or second level RVQoE configuration item(s)) for MBS, indicating that a QoE-related (and/or RVQoE-related) operation for MBS pertaining to a second level QoE configuration item (or second level RVQoE configuration item) for MBS whose corresponding application session's data is delivered via MBS is enabled (or is not enabled, or can continue, or cannot continue, or is paused, or is resumed)
(mobility from a first RAN node supporting MBS to a second RAN node supporting MBS) an indication, applicable in case of mobility from a first RAN node (e.g., network node 16) (or a first cell of a first RAN node) supporting MBS to a second RAN node (e.g., network node 16) (or a second cell of a second RAN node) supporting MBS, and the indication being valid for any, or for each, or for all of the second level QoE configuration item(s) (or second level RVQoE configuration item(s)) for MBS, and for which the corresponding first level QoE configuration item (or first level RVQoE configuration item) for MBS, the indication indicating that a QoE-related (and/or RVQoE-related) operation for MBS concerning application session's data delivered via MBS or via Unicast is enabled (or is not enabled, or can continue, or cannot continue, or is paused, or is resumed). The first RAN node and the second RAN node may be different RAN nodes or one and the same RAN node.
(mobility from a first RAN node supporting MBS to a second RAN node not supporting MBS) an indication, applicable in case of mobility from a first RAN node (or a first cell of a first RAN node) supporting MBS to a second RAN node (or a second RAN node of a second RAN node) not supporting MBS, and the indication being valid for any, or for each, or for all of the second level QoE configuration item(s) (or second level RVQoE configuration item(s)) for MBS, and for which the corresponding first level QoE configuration item (or first level RVQoE configuration item) for MBS, the indication indicating that a QoE-related (and/or QoE-related) operation for MBS concerning application session's data delivered via MBS or via Unicast is enabled (or is not enabled, or can continue, or cannot continue, or is paused, or is resumed). The first RAN node and the second RAN node may be different RAN nodes or one and the same RAN node. When the first RAN node and the second RAN node are the same RAN node, the property of support or no support for MBS is associated with the first and the second cell, i.e., the cells between which the mobility occurs.
(mobility from a first RAN node not supporting MBS to a second RAN node supporting MBS) an indication, applicable in case of mobility from a first RAN node (or a first cell of a first RAN node) not supporting MBS to a second RAN node (or a second cell of a second RAN node) supporting MBS, and the indication being valid for any, or for each, or for all of the second level QoE configuration item(s) (or second level RVQoE configuration item(s)) for MBS, and for which the corresponding first level QoE configuration item (or first level RVQoE configuration item) for MBS, the indication indicating that a QoE-related (and/or RVQoE-related) operation for MBS concerning application session's data delivered via Unicast (or at least not via MBS) is enabled (or is not enabled, or can continue, or cannot continue, or is paused, or is resumed). If continuation/resume is possible/indicated, the application session data can be delivered using MBS or Unicast. The first RAN node and the second RAN node may be different RAN nodes or one and the same RAN node. When the first RAN node and the second RAN node are the same RAN node, the property of support or no support for MBS is associated with the first and the second cell, i.e., the cells between which the mobility occurs.
(mobility from a first RAN node not supporting MBS to a second RAN node not supporting MBS) an indication, applicable in case of mobility from a first RAN node (or a first cell of a first RAN node) not supporting MBS to a second RAN node (or a second cell of the second RAN node) also not supporting MBS, the indication being valid for any, or for each, or for all of the second level QoE configuration item(s) (or second level RVQoE configuration item(s)) for MBS, and for which the corresponding first level QoE configuration item (or first level RVQoE configuration item) for MBS, the indication indicating that a QoE-related (and/or RVQoE-related) operation for MBS concerning application session's data delivered via Unicast (or at least not via MBS) is enabled (or is not enabled, or can continue, or cannot continue, or is paused, or is resumed). The first RAN node and the second RAN node may be different RAN nodes or one and the same RAN node.
(mobility from a first RAN node to a second RAN node of the same RAT) an indication, applicable in case of mobility from a first RAN node (or a first cell of a first RAN node) to a second RAN node (or a second cell of a second RAN node) of the same RAT, the indication being valid for any, or for each, or for all of the second level QoE configuration item(s) (or second level RVQoE configuration item(s)) for MBS, and for which the corresponding first level QoE configuration item (or first level RVQoE configuration item) for MBS, the indication indicating that a QoE-related (and/or RVQoE related) operation for MBS concerning application session's data delivered via Unicast (or at least not via MBS) is enabled (or is not enabled, or can continue, or cannot continue, or is paused, or is resumed). If continuation/resume is possible/indicated, the application session data can be delivered using MBS or Unicast. The first RAN node and the second RAN node may be different RAN nodes or one and the same RAN node.
(mobility from a first RAN node to a second RAN node of any RAT) an indication, in case of mobility from a first RAN node (or a first cell of a first RAN node) to a second RAN node (or a second cell of a second RAN node of any RAT), the indication being valid for any, or for each, or for all of the second level QoE configuration item(s) (or second level RVQoE configuration item(s)) for MBS, and for which the corresponding first level QoE configuration item (or first level RVQoE configuration item) for MBS, the indication indicating that a QoE-related (and/or RVQoE-related) operation for MBS concerning application session's data delivered via Unicast (or at least not via MBS) is enabled (or is not enabled, or can continue, or cannot continue, or is paused, or is resumed). If continuation/resume is possible/indicated, the application session data can be delivered using MBS or Unicast. The first RAN node and the second RAN node may be different RAN nodes or one and the same RAN node.
(mobility from a first RAN node of a first RAT to another RAN node of a second RAT) an indication, applicable in case of mobility from a first RAT to a second RAT (or from a first RAN node of a first RAT to a second RAN node of a second RAT, or a first cell of a first RAN node of a first RAT to a second cell of a second RAN node of a second RAT), the indication being valid for any, or for each, or for all of the second level QoE configuration item(s) (or second level RVQoE configuration item(s)) for MBS, and for which the corresponding first level QoE configuration item (or first level RVQoE configuration item) for MBS, the indication indicating that a QoE-related (and/or RVQoE-related) operation for MBS concerning application session's data delivered via MBS or via Unicast is enabled (or is not enabled, or can continue, or cannot continue, or is paused, or is resumed). The above may be combined in all possible combinations in terms of support for MBS at the first RAN node of the first RAT and/or at the second RAN node of the second RAT. The first RAN node and the second RAN node may be different RAN nodes or one and the same RAN node. When the first RAN node and the second RAN node are the same RAN node, the RAT is a property of the first and the second cell, i.e., the cells between which the mobility occurs.
(reconfiguration from single connectivity to multiple connectivity, or vice versa, or from a first configuration for multiple connectivity to a second configuration for multiple connectivity) an indication, for any, or for each, or for all of the second level QoE configuration item(s) (or second level RVQoE configuration item(s)) for MBS, and for which the corresponding first level QoE configuration item (or first level RVQoE configuration item) for MBS, indicating that a QoE-related (and/or RVQoE-related) operation for MBS concerning application session's data delivered via MBS or via Unicast is enabled (or is not enabled, or can continue, or cannot continue, or is paused, or is resumed) in case of reconfiguration from single connectivity to multiple connectivity (or vice versa), or in case of reconfiguration form a first configuration for multiple connectivity to a second configuration for multiple connectivity.
an indication, for any, or for each, or for all of the second level QoE configuration item(s) (or second level RVQoE configuration item(s)) for MBS, indicating that a QoE-related (and/or RVQoE-related) operation for MBS pertaining to a second level QoE configuration item (or second level RVQoE configuration item) for MBS whose corresponding application session's data is delivered via MBS is enabled (or is not enabled, or can continue, or cannot continue, or is paused, or is resumed) upon any of the following changes:
   change from MBS to Unicast
   change from Unicast to MBS
   any change between MBS and Unicast and vice versa
   change from MBS Multicast to Unicast
   change from MBS Broadcast to Unicast
   change from Unicast to MBS Multicast
   change from Unicast to MBS Broadcast
   change from MBS Multicast using PTM to Unicast
   change from MBS Multicast using PTP to Unicast
   change from Unicast to MBS Multicast using PTM
   change from Unicast to MBS Multicast using PTP
   any change between MBS delivery modes,
   change from MBS Multicast to MBS Broadcast,
   change from MBS Broadcast to MBS Multicast,
   change from MBS Broadcast to MBS Multicast using PTM,
   change from MBS Broadcast to MBS Multicast using PTP,
   change from MBS Multicast using PTM to MBS Broadcast,
   change from MBS Multicast using PTP to MBS Broadcast,
   change from MBS Multicast using PTM to MBS Multicast using PTP,
   change from MBS Multicast using PTP to MBS Multicast using PTM.

According to one or more embodiments, QoE-related indications or operations may refer to: indications or operations concerning the handling (configuration of measurements, performing measurements and reporting of measurements) of QoE measurements for MBS, when, for example, application layer measurements are not interpretable/readable by the Access Stratum of a wireless device 22 and are not interpretable/readable by a network node 16 (e.g., RAN node).

According to one or more embodiments, RVQoE-related indications or operations may refer to: indications or operations concerning the handling (configuration of measurements, performing measurements and reporting of measurements) of RAN visible QoE, RVQoE, measurements for MBS, for application layer measurements that are, for example, interpretable/readable by the Access Stratum of a wireless device 22 and/or by a network node 16 (e.g., RAN node).

In any of the above, the order between first level QoE configuration item (or first level RVQoE configuration item) for MBS and the second level QoE configuration item (or second level RVQoE configuration item) can be inverted.

In a first example, a QoE configuration can include an indication (e.g., a Service Type Delivery Method Reporting or alike) indicating that wireless device 22 may/can/shall include in QoE/RVQoE reports that MBS (or one of its variants) is used as service type delivery method.

In another example, as part of a QoE configuration or as separate information, a network node 16 can send to another network node 16 (e.g., within an XnAP message), an indication (e.g., a Service Type Delivery Change Allowed, or alike), indicating that a wireless device 22 may/can/shall continue (or stop) performing QoE measurements (or RVQoE measurements) when service type delivery method for delivering data associated to a service type is changed from a first form to a second form (e.g., from Multicast to Unicast).

In another example, as part of a QoE configuration or as separate information, a network node 16 can send to another network node 16 (e.g., within an XnAP message), an indication (e.g., a Service Type Delivery Method Change Allowed, or alike), indicating that a wireless device 22 may/can/shall continue (or pause, or stop, or resume) reporting QoE measurements (or RVQoE measurements) when service type delivery method for delivering data associated to a service type is changed from a first form to a second form (e.g., from Multicast to Unicast).

In another example, as part of a QoE configuration or as separate information, a network node 16 can send to another network node 16 or to a wireless device 22 an indication (e.g., a Service Type Delivery Method Change Indication, or alike), indicating that a wireless device 22 is to indicate together with or as part of a QoE/RVQoE report whether and how the service type delivery method for delivering data associated to a service type has changed from a first form to a second form (e.g., from Multicast to Unicast).

Indications concerning QoE-related (and/or RVQoE-related) operations when mobility takes place between the two RAN nodes (e.g., network nodes 16) where the first RAN supports MBS, while the second RAN node supports MBMS, or vice versa can be the following:
(mobility from a first RAN node supporting MBS to a second RAN node supporting MBMS) if a wireless device 22 is configured to know that the same service is provided over MBS and eMBMS via the common (to MBS and MBMS) TMGI. In this case, indications in QoE report (if the second RAN node supports QoE measurements) about the change of bearers from MRBs to MBMS bearers, include MBMS Session Identity. This option may be applicable to the cases where QoE measurement collection is supported but not for the RVQoE, depending on the second RAN node capability related to the QoE/RVQoE measurement collection. Indicate in the QoE report one or a combination of the following:
   Change of delivery method from PTP to either of the MBMS delivery methods:
      Streaming MBMS
      Download MBMS,
      Transparent MBMS,
      Group Communication MBMS
   Change of delivery method from PTM to either of the MBMS delivery methods:
      Streaming MBMS,
      Download MBMS,
      Transparent MBMS,
      Group Communication MBMS
   Change of service delivery method from MBS to MBMS,
   Change of delivery method from MBS Multicast to MBMS,
   Change of delivery method from MBS Broadcast to MBMS,
   Change of data radio bearer:
      From MRB to MBMS bearer
      From MBS to Unicast bearer (Unicast Bearer Service based MBMS User Service as described in, for example, 3GPP TS 26.346
(mobility from a first RAN node supporting MBMS to a second RAN node supporting MBS), provided that the first RAN node supports QoE measurement collection to begin with, include in the QoE report MBS Session ID, indicate changes from MBMS radio bearers to MBS radio bearers.
   If the first network node 16 does not support the QoE measurement collection, but the second RAN node (e.g., second network node 16) supports the QoE measurement collection, the second RAN node could send via dedicated signalling the MBS-associated QoE measurement configuration simultaneously to wireless device 22 from the MBMS Session joining the MBS Session
   If the first network node 16 supports LTE QoE measurement collection in the case that services supported by an LTE QoE were delivered, but the second RAN node supports the NR QoE measurement collection, the new MBS-related QoE configuration may be sent to a wireless device 22.

In all of the above examples of indications involving mobility, the mobility may be different kinds of mobility procedures, including e.g., handover, conditional handover, connection re-establishment, PSCell change, conditional PSCell change and cell re-selection (where cell re-selection occurs in RRC_IDLE and/or RRC_INACTIVE state), for example.

In another embodiment, a first network node 16 sends to a second network node 16 a QoE/RVQoE report and/or QoE related event for MBS.

In another embodiment, a first network node 16 sends to a second network node 16 a QoE/RVQoE report and/or QoE related event for an application session (where the application belongs to a certain service type indicated in a corresponding QoE/RVQoE configuration) carried at least in part over MBS.

In another embodiment, a first network node 16 sends to a second network node 16 a QoE/RVQoE configuration for MBS.

In another embodiment, a first network node 16 sends to a second network node 16 a QoE/RVQoE configuration, configuring QoE/RVQoE measurements on sessions of an application (where the application belongs to a certain service type indicated in a corresponding QoE/RVQoE configuration) carried at least in part over MBS.

### Example Embodiments for a Wireless Device 22

In one embodiment, a wireless device 22 or group or wireless devices 22 receive(s) from a first network node 16 (e.g., a first RAN node) a QoE/RVQoE configuration for MBS including:
a first level QoE-configuration item (or RVQoE configuration item) for MBS, where the first level QoE-configuration item (or RVQoE configuration item) for MBS indicates MBS as one of:
   a service
   a service type
   a communication service
   a communication service type
   a delivery service
   a delivery method
   a delivery type
   a service delivery type
   a service type delivery
   a service type delivery method
   a traffic type
   a type of delivery method
   a service subtype
   a subservice type
   an indication of MBS
   an indication of a form of MBS (e.g., delivery mode, such as MBS Multicast, MBS Broadcast, MBS PTM, or MBS PTP)
      and wherein the first level QoE configuration item (or first level RVQoE configuration item) may refer to MBS in general or one of the possible forms of MBS, such as MBS Multicast, MBS Broadcast, MBS PTM, or MBS PTP.
      and
one or more second level QoE configuration item(s) (or second level RVQoE configuration item(s)) for MBS, where a second level QoE configuration item (or RVQoE configuration item) for MBS indicates one or more of the following:
   a service
   a session
   a service type)
   a service subtype
   a subservice type
   a service in/over MBS
   a session in/over MBS
   a service type in/over MBS
   a service subtype in/over MBS
   a subservice type in/over MBS
      where a second level QoE configuration item (or second level RVQoE configuration item) for MBS is associated with an application matching the indicated service type (or range of applications providing the type of service indicated by the second level QoE configuration item (or second level RVQoE configuration item)) associated to application session(s) whose data is delivered (or can be delivered) via MBS.

In one variant of this embodiment, the order between the first level QoE configuration item (or first level RVQoE configuration item) for MBS and the second level QoE configuration item (or second level RVQoE configuration item) for MBS is inverted (as described in the embodiment for the network node).

In one embodiment, a wireless device 221 sends to a first network node 16 (e.g., a first RAN node) a QoE report or a RVQoE report or a QoE related event for MBS including one or more of:
an indication, indicating that the report/event pertains to MBS (as indicated in one of the indications comprised in the first level QoE-configuration item (or first level RVQoE configuration item) for MBS (e.g., a service type, a communication service, a delivery service, a service delivery type, a service type delivery, a service type delivery method, a service subtype, a subservice type)).
an indication, indicating that the report/event pertains to one of the one or more second level QoE configuration item(s) (or second level RVQoE configuration item(s)) for MBS (e.g., a service type, or a service type over MBS)
timestamps indicating start time and/or end time (or time period) for QoE (or RVQoE) measurements related to application session data delivered via MBS
   This information may be further detailed, e.g., indicating timestamps for start and/or end times (or time period) for QoE (or RVQoE) measurements related to application session data delivered via MBS Multicast or MBS Broadcast, and for MBS Multicast the time information may be further detailed into time information for periods of respectively PTM or PTP delivery modes.
timestamps indicating start time and/or end time (or time period) for QoE (or RVQoE) measurements related to application session data delivered via Unicast
timestamps indicating start time and/or end time (or time period) for QoE (or RVQoE) measurements of a second level QoE configuration item (or a second level RVQoE configuration item) for MBS whose application session data is delivered via MBS
   This information may be further detailed, e.g., indicating timestamps for start and/or end times (or time period) for QoE (or RVQoE) measurements related to application session data delivered via MBS Multicast or MBS Broadcast, and for MBS Multicast the time information may be further detailed into time information for periods of respectively PTM or PTP delivery modes.
timestamps indicating start time and/or end time (or time period) for QoE (or RVQoE) measurements of a second level QoE configuration item (or a second level RVQoE configuration item) for MBS whose application session data is delivered via Unicast
an indication, indicating whether MBS has been used to deliver at least a portion of the application session's data or has not been used for delivery of any of the application session's data
   This information may be further detailed, e.g., indicating:
      whether at least a portion to application session data was delivered via MBS Multicast,
      whether at least a portion to application session data was delivered via MBS Broadcast,
      whether at least a portion to application session data was delivered using the PTM delivery mode, and/or
      whether at least a portion to application session data was delivered via the PTP delivery mode.
an indication, indicating whether Unicast has been used for delivery of at least a portion of the application session's data or has not been used for delivery of any of the application session's data
indication(s), indicating whether MBS has been used for delivery of at least a portion of the application session's data or has not been used for delivery of any of the application session's data for one of the one or more second level QoE configuration item(s) (or RVQoE configuration item(s)) for MBS
indication(s), indicating whether Unicast has been used for delivery of at least a portion of the application session's data or has not been used for delivery of any of the application session's data for one of the one or more second level QoE configuration item(s) (or RVQoE configuration item(s)) for MBS
indication(s), indicating whether MBS has been used for delivery of at least a portion of the application session's data or has not been used for delivery of any of the application session's data before/after/during preparation or execution of a certain procedure for MBS (see below what “procedure for MBS” means)
indications, indicating whether Unicast has been used for delivery of at least a portion of the application session's data or has not been used for delivery of any of the application session's data before/after/during preparation or execution of certain procedure for MBS (see below what “procedure for MBS” means)
indications, indicating whether MBS has been used for delivery of at least a portion of the application session's data or has not been used for delivery of any of the application session's data associated to one or more second level QoE configuration item(s) (or RVQoE configuration item(s)) for MBS before/after/during preparation or execution of certain procedure for MBS (see below what “procedure for MBS” means)
indications, indicating whether Unicast has been used for delivery of at least a portion of the application session's data or has not been used for delivery of any of the application session's data associated to one or more second level QoE configuration item(s) (or RVQoE configuration item(s)) for MBS before/after/during preparation or execution of certain procedure for MBS (see below what “procedure for MBS” means)

In any of the above description/embodiments/examples, the order between first level QoE configuration item (or first level RVQoE configuration item) for MBS and the second level QoE configuration item (or second level RVQoE configuration item) can be inverted.

In the above examples of QoE/RVQoE report content, a procedure for MBS can be:
mobility from a first RAN node (e.g., first network node 16) (or a first cell provided by the first network node 16) supporting MBS to a second RAN node (e.g., second network node 16) (or a second cell provided by the second network node 16) supporting MBS.
   The first RAN node and the second RAN node may be different RAN nodes or one and the same RAN node.
mobility from a first RAN node (or a first cell) supporting MBS to a second RAN node (or a second cell) not supporting MBS
   The first RAN node and the second RAN node may be different RAN nodes or one and the same RAN node. If the first RAN node and the second RAN node are one and the same RAN node, the property of supporting or not supporting MBS is associated with the first cell and the second cell (i.e., the cells which the mobility occurs between).
mobility from a first RAN node (or a first cell) not supporting MBS to a second RAN node (or a second cell) supporting MBS
   If the first RAN node and the second RAN node are one and the same RAN node, and/or if the first RAN node and the second RAN node are one and the same RAN node, the property of supporting or not supporting MBS is associated with the first cell and the second cell (i.e., the cells which the mobility occurs between).
mobility from a first RAN node (or a first cell) not supporting MBS to a second RAN node (or a second cell) not supporting MBS.
   If the first RAN node and the second RAN node are one and the same RAN node,
mobility from a first RAN node of a first RAT to a second RAN node of a second RAT (in all possible combinations in terms of support for MBS at the first RAN node of the first RAT and/or at the second RAN node of the second RAT).
   The first RAN node and the second RAN node may be different RAN nodes or one and the same RAN node. If the first RAN node and the second RAN node are one and the same RAN node, this RAN node has cells of different RATs among the cells it serves, and the mobility occurs from a first cell of first RAT to a second cell of a second RAT.
reconfiguration from single connectivity to multiple connectivity, or vice versa, or from a first configuration for multiple connectivity to a second configuration for multiple connectivity
mobility from a first RAN node (or a first cell of a first RAN node) operating in shared spectrum to a second RAN node (or a second cell of a second RAN node) operating in shared spectrum
mobility from a first RAN node (or a first cell of a first RAN node) operating in licensed spectrum to a second RAN node (or a second cell of a second RAN node) operating in licensed spectrum
mobility from a first RAN node (or a first cell of a first RAN node) operating in shared spectrum to a second RAN node (or a second cell of a second RAN node) operating in licensed spectrum (or vice versa)
change between MBS delivery modes within the same cell, wherein the change of delivery mode which is applicable for this MBS procedure (i.e., when this MBS procedure is indicated) may be one or more of:
   any change between MBS delivery modes,
   change from MBS Multicast to MBS Broadcast,
   change from MBS Broadcast to MBS Multicast,
   change from MBS Broadcast to MBS Multicast using PTM,
   change from MBS Broadcast to MBS Multicast using PTP,
   change from MBS Multicast using PTM to MBS Broadcast,
   change from MBS Multicast using PTP to MBS Broadcast,
   change from MBS Multicast using PTM to MBS Multicast using PTP,
   change from MBS Multicast using PTP to MBS Multicast using PTM
change between delivery modes in conjunction with change of cells, where the change of delivery mode which is applicable for this MBS procedure (i.e., when this MBS procedure is indicated) may be one or more of:
   any change between MBS delivery modes,
   change from MBS Multicast to MBS Broadcast,
   change from MBS Broadcast to MBS Multicast,
   change from MBS Broadcast to MBS Multicast using PTM,
   change from MBS Broadcast to MBS Multicast using PTP,
   change from MBS Multicast using PTM to MBS Broadcast,
   change from MBS Multicast using PTP to MBS Broadcast,
   change from MBS Multicast using PTM to MBS Multicast using PTP,
   change from MBS Multicast using PTP to MBS Multicast using PTM
change from MBS to Unicast
change from Unicast to MBS
any change between MBS and Unicast and vice versa
change from MBS Multicast to Unicast
change from MBS Broadcast to Unicast
change from Unicast to MBS Multicast
change from Unicast to MBS Broadcast
change from MBS Multicast using PTM to Unicast
change from MBS Multicast using PTP to Unicast
change from Unicast to MBS Multicast using PTM and/or
change from Unicast to MBS Multicast using PTP

### EXAMPLES OF IMPLEMENTATION

In the following, examples of implementations to support QoE for MBS are provided.

In a first example, additions to UE Layer Measurement Configuration Information IE in 3GPP standards such as in, for example, 3GPP TS 38.413 are shown below in Table 2, marked in bold, underlined and italic.

TABLE 2
UE Application Layer Measurement Configuration Information. This
IE defines configuration information for the QMC functionality.

| | | | | |
|---|---|---|---|---|
| | | | IE type and | |
| IE/Group Name | Presence | Range | reference | Semantics description |

| | | | |
|---|---|---|---|
| QoE Reference | M | OCTET STRING | QoE Reference, as |
| | | (SIZE(6)) | defined in clause 5.2 |
| | | | of 3GPP TS 28.405. |
| | | | It consists of |
| | | | MCC + MNC + QMC |
| | | | ID, where the MCC |
| | | | and MNC are coming |
| | | | with the QMC |
| | | | activation request |
| | | | from the management |
| | | | system to identify |
| | | | one PLMN |
| | | | containing the |
| | | | management system, |
| | | | and QMC ID is a 3- |
| | | | bytes Octet String. |
| Service Type | M | ENUMERATED | This IE indicates the |
| | | (QMC for DASH | service type of QoE |
| | | streaming, QMC | measurements. |
| | | for MTSI, QMC | |
| | | for VR, . . . ) | |
| ( . . . skip | | | |
| unchanged) | | | |
| Service Type | O | ENUMERATED | This IE indicates |
| Delivery Method | | (multicast, | whether the service |
| | | broadcast, . . . ) | type is or can be |
| | | | delivered using |
| | | | multicast or |
| | | | broadcast. |
| Service Type | O | ENUMERATED | This IE indicates |
| Delivery Method | | (True) | whether the WD |
| Reporting | | | shall include in QoE |
| | | | reports (and in |
| | | | RVQoE reports) the |
| | | | service type delivery. |
| Applicability | O | ENUMERATED | This IE indicates |
| | | (only when MBS | whether the QoE |
| | | is used, also when | measurement |
| | | MBS is not used) | configuration in this |
| | | | tabular applies also |
| | | | when MBS is not |
| | | | used to deliver a |
| | | | session for the |
| | | | service type indicated |
| | | | in the Service Type |
| | | | IE. |

TABLE 3

| Range bound | Explanation |
|---|---|
| maxnoofCellIDforQMC | Maximum no. of Cell ID subject for QMC |
| | scope. Value is 32. |
| maxnoofTAforQMC | Maximum no. of TA subject for QMC |
| | scope. Value is 8. |
| maxnoofPLMNforQMC | Maximum no. of PLMNs in the PLMN list |
| | for QMC scope. Value is 16. |
| maxnoofSNSSAIforQMC | Maximum no. of S-NSSAIs in the S-NSSAI |
| | list for QMC scope. Value is 16. |

In a variant of this example, the additional IE can be used to indicate to an NG-RAN node to configure the wireless device 22 for including in QoE/RVQoE report (or to indicate together with the QoE/RVQoE reports) whether MBS (or MBS multicast, or MBS Broadcast, or any combination of those) was used as service type delivery/delivery type/service type/service subtype or any variants described in the preceding embodiments.

TABLE 4

| | | | |
|---|---|---|---|
| Service Type Delivery | O | ENUMERATED | This IE indicates whether |
| Method | | (multicast, | the WD should report in a |
| | | broadcast, unicast, | QoE report (or in a |
| | | . . . ) | RVQoE report) whether |
| | | | multicast, broadcast or |
| | | | unicast was used for |
| | | | delivering the data |
| | | | associated to a given QoE |
| | | | report (or to a given |
| | | | RVQoE report). |

In another variant of this example, the additional IE can be used to indicate whether the wireless device 22 should perform QoE measurements (or RVQoE 10 measurements) when multicast or broadcast (or MBS Multicast, or MBS Broadcast) is used for the delivery of data associated to a service type.

TABLE 5

| | | | |
|---|---|---|---|
| Service Type Delivery | O | ENUMERATED | This IE indicates |
| Method | | (multicast, | whether the WD should |
| | | broadcast, . . . ) | performs QoE |
| | | | measurements (or |
| | | | RVQoE measurements) |
| | | | when multicast or |
| | | | broadcast is used for |
| | | | the delivery of data |
| | | | associated to the service |
| | | | type |

In a second example, additions to III: Application Layer Measurement Configuration Information IE in 3GPP standards such as in, for example, 3GPP TS 38.423 are shown below, marked in bold, underlined and italic in Table 6.

TABLE 6
UE Application Layer Measurement Configuration Information. This IE defines
the information about the QoE Measurement Collection (QMC) configuration

| | | | | |
|---|---|---|---|---|
| | | | IE type | |
| | | | and | |
| IE/Group Name | Presence | Range | reference | Semantics description |

| | | | |
|---|---|---|---|
| QoE Reference | M | OCTET | QoE Reference, as defined in |
| | | STRING | clause 5.2 of 3GPP TS |
| | | (SIZE(6)) | 28.405. It consists of |
| | | | MCC + MNC + QMC ID, |
| | | | where the MCC and MNC |
| | | | are coming with the QMC |
| | | | activation request from the |
| | | | management system to |
| | | | identify one PLMN |
| | | | containing the management |
| | | | system, and QMC ID is a 3 |
| | | | bytes Octet String. |
| Measurement | O | INTEGER | This IE indicates the identity |
| Configuration | | (0 . . . 15, . . . ) | of the application layer |
| Application Layer | | | measurement configuration, |
| ID | | | as defined in 3GPP TS |
| | | | 38.331. |
| Service Type | M | ENUMERATED | This IE indicates the service |
| | | (QMC for | type of QoE measurements. |
| | | DASH | |
| | | streaming, | |
| | | QMC for | |
| | | MTSI, | |
| | | QMC for | |
| | | VR, . . . ) | |
| (skip unchanged) | | | |
| Service Type | O | ENUMERATED | This IE indicates whether |
| Delivery Method | | (multicast, | the service type can be |
| | | broadcast, | delivered using multicast or |
| | | . . . ) | broadcast. |

TABLE 7

| Range bound | Explanation |
|---|---|
| maxnoofCellIDforQMC | Maximum no. of Cell IDs comprising the |
| | QMC scope. Value is 32. |
| maxnoofTAforQMC | Maximum no. of TA comprising the QMC |
| | scope. Value is 8. |
| maxnoofPLMNforQMC | Maximum no. of PLMNs in the PLMN list |
| | for QMC scope. Value is 16. |
| maxnoofSNSSAIforQMC | Maximum no. of S-NSSAIs comprising the |
| | QMC scope. Value is 16. |

In another variant of this example the additional IE can be used to indicate whether the wireless device 22 should continue to perform QoE measurements (or RVQUE measurements) when multicast or broadcast (or MBS Multicast, or MBS Broadcast) is used for the delivery of data associated to a service type.

TABLE 8

| | | | |
|---|---|---|---|
| Service Type | O | ENUMERATED | This IE indicates |
| Delivery | | (multicast, broadcast, | whether the WD should |
| | | . . . ) | continue to perform |
| | | | QoE measurements (or |
| | | | RVQoE measurements) |
| | | | when multicast or |
| | | | broadcast is used for |
| | | | delivering data |
| | | | associated to the service |
| | | | type |

In another variant of this example, the additional IE can be used to indicate whether the wireless device 22 should continue to perform QoE measurements (or RVQoE measurements) when the form of delivery is changed due to mobility (e.g., from multicast to unicast) for a given service type.

TABLE 9

| | | | |
|---|---|---|---|
| Service type | O | ENUMERATED | This IE indicates |
| Delivery Method | | (multicast-to- | whether the WD should |
| Change Allowed | | unicast, unicast- | continue to perform |
| | | to-multicast, | QoE measurements (or |
| | | broadcast-to- | RVQoE measurements) |
| | | unicast, unicast- | when service type |
| | | to-broadcast, . . . ) | delivery method for |
| | | | delivering data |
| | | | associated to the service |
| | | | type is changed |

In another variant of this example the additional IE can be used to indicate whether the wireless device 22 should report a change in the form of delivery (e.g., from multicast to unicast) for a given service type.

TABLE 10

| | | | |
|---|---|---|---|
| Service type | O | ENUMERATED | This IE indicates |
| Delivery Method | | (multicast-to- | whether the QoE report |
| Change Indication | | unicast, unicast- | or a RVQoE report |
| | | to-multicast, | should contain an |
| | | broadcast-to- | indication of whether |
| | | unicast, unicast- | and how the service type |
| | | to-broadcast, . . . ) | delivery method for |
| | | | delivering data |
| | | | associated to the service |
| | | | type is changed |

Hence, one or more embodiments provide various options for designing the signaling related to configuration and reporting of QoE/RVQoE measurements for MBS. For example, in one option, when MBS is used for delivering data for an application, the QoE configuration indicates that MBS is a service type and includes QoE related configuration or indications for one or more other service types.

One or more embodiments, advantageously enable a network operator to configure wireless devices 22 to perform QoE/RVQoE measurements for MBS in combination with application sessions whose data flows are carried by MBS.

### SOME EXAMPLES

Example A1. A network node 16 configured to communicate with a wireless device 22, the network node 16 configured to, and/or comprising a radio interface 62 and/or comprising processing circuitry 68 configured to:
one of receive and determine a first level quality of experience, QoE, configuration item for multicast and broadcast service, MBS;
one of receive and determine a second level QoE configuration item for MBS, the second level QoE configuration being different from the first level QoE configuration item and associated with an application whose data is delivered by MBS; and
indicate the first level QoE configuration item and second level QoE configuration item to the wireless device 22.

Example A2. The network node 16 of Example A1, wherein the first level QoE configuration item indicates at least one of:
a service;
a service type;
a communication service;
a communication service type;
a delivery service;
a delivery method;
a delivery type;
a service delivery type;
a service type delivery;
a service type delivery method;
a traffic type;
a type of delivery method;
a service subtype;
a subservice type;
an indication indicating MBS;
an indication of a form of MBS; and
an indication of a hybrid delivery type.

Example A3. The network node 16 of Example A1, wherein the second level QoE configuration item indicates at least one of:
a service;
a session;
a service type;
a service subtype;
a subservice type;
a service one of in and over MBS;
a session one of in and over MBS;
a service type one of in and over MBS;
a service subtype one of in and over MBS; and
a subservice type one of in and over MBS.

Example A4. The network node 16 of any one of Examples A1-A3, wherein the first level QoE configuration item is a first radio access network, RAN, visible QoE, RVQoE, configuration item and the second level QoE configuration item is a second RVQoE configuration item.

Example A5. The network node 16 of any one of Examples A1-A4, wherein at least one of the first level QoE configuration item and second level QoE configuration item indicate QoE measurements are configured for MBS for one of a service type and predefined service types.

Example A6. The network node 16 of Example A5, wherein the service type and predefined service types include at least one of dynamic adaptive streaming over HTPP, DASH, streaming, a virtual reality and augmented reality.

Example A7. The network node 16 of any one of Examples A1-A6, wherein the indication of the first level QoE configuration item and second level QoE configuration item to the wireless device 22 includes an indication whether one of MBS, broadcast, MBS broadcast, MBS multicast and unicast has been used to deliver data associated with a session of the application.

Example B1. A method implemented in a network node 16 that is configured to communicate with a wireless device 22, the method comprising:
one of receiving and determining a first level quality of experience, QoE, configuration item for multicast and broadcast service, MBS;
one of receiving and determining a second level QoE configuration item for MBS, the second level QoE configuration being different from the first level QoE configuration item and associated with an application whose data is delivered by MBS; and
indicating the first level QoE configuration item and second level QoE configuration item to the wireless device 22.

Example B2. The method of Example B1, wherein the first level QoE configuration item indicates at least one of:
a service;
a service type;
a communication service;
a communication service type;
a delivery service;
a delivery method;
a delivery type;
a service delivery type;
a service type delivery;
a service type delivery method;
a traffic type;
a type of delivery method;
a service subtype;
a subservice type;
an indication indicating MBS;
an indication of a form of MBS; and
an indication of a hybrid delivery type.

Example B3. The method of Example B1, wherein the second level QoE configuration item indicates at least one of:
a service;
a session;
a service type;
a service subtype;
a subservice type;
a service one of in and over MBS;
a session one of in and over MBS;
a service type one of in and over MBS;
a service subtype one of in and over MBS; and
a subservice type one of in and over MBS.

Example B4. The method of any one of Examples B1-B3, wherein the first level QoE configuration item is a first radio access network, RAN, visible QoE, RVQoE, configuration item and the second level QoE configuration item is a second RVQoE configuration item.

Example B5. The method of any one of Examples B1-B4, wherein at least one of the first level QoE configuration item and second level QoE configuration item indicate QoE measurements are configured for MBS for one of a service type and predefined service types.

Example B6. The method of Example B5, wherein the service type and predefined service types include at least one of dynamic adaptive streaming over HTPP, DASH, streaming, a virtual reality and augmented reality.

Example B7. The method of any one of Examples B1-B6, wherein the indication of the first level QoE configuration item and second level QoE configuration item to the wireless device includes an indication whether one of MBS, broadcast, MBS broadcast, MBS multicast and unicast has been used to deliver data associated with a session of the application.

Example C1. A wireless device 22 configured to communicate with a network node 16, the WD 22 configured to, and/or comprising a radio interface 82 and/or processing circuitry 84 configured to:
receive an indication of a first level quality of experience, QoE, configuration item and second level QoE configuration item for multicast and broadcast service, MBS, the second level QoE configuration being different from the first level QoE configuration item and associated with an application whose data is delivered by MBS; and
perform at least one action based on the received indication.

Example C2. The wireless device 22 of Example C1, wherein the first level QoE configuration item indicates at least one of:
a service;
a service type;
a communication service;
a communication service type;
a delivery service;
a delivery method;
a delivery type;
a service delivery type;
a service type delivery;
a service type delivery method;
a traffic type;
a type of delivery method;
a service subtype;
a subservice type;
an indication indicating MBS;
an indication of a form of MBS; and
an indication of a hybrid delivery type.

Example C3. The wireless device 22 of Example C1, wherein the second level QoE configuration item indicates at least one of:
a service;
a session;
a service type;
a service subtype;
a subservice type;
a service one of in and over MBS;
a session one of in and over MBS;
a service type one of in and over MBS;
a service subtype one of in and over MBS; and
a subservice type one of in and over MBS.

Example C4. The wireless device 22 of any one of Examples C1-C3, wherein the first level QoE configuration item is a first radio access network, RAN, visible QoE, RVQoE, configuration item and the second level QoE configuration item is a second RVQoE configuration item.

Example C5. The wireless device 22 of any one of Examples C1-C4, wherein at least one of the first level QoE configuration item and second level QoE configuration item indicate QoE measurements are configured for MBS for one of a service type and predefined service types.

Example C6. The wireless device 22 of Example C5, wherein the service type and predefined service types include at least one of dynamic adaptive streaming over HTPP, DASH, streaming, a virtual reality and augmented reality.

Example C7. The wireless device 22 of any one of Examples C1-C6, wherein the indication of the first level QoE configuration item and second level QoE configuration item includes an indication whether one of MBS, broadcast, MBS broadcast, MBS multicast and unicast has been used to deliver data associated with a session of the application.

Example C8. The wireless device 22 of any one of Examples C1-C7, wherein the at least one action includes sending a QoE report to the network node, the QoE report indicating one of:
timestamps indicating a start time and/or end time for QoE measurements related to application session data delivered via one of MBS, unicast, MBS multicast and MBS broadcast; and
whether one of unicast and MBS has been used for delivery of at least a portion of the application session's data.

Example D1. A method implemented in a wireless device 22 that is configured to communicate with a network node 16, the method comprising:
receiving an indication of a first level quality of experience, QoE, configuration item and second level QoE configuration item for multicast and broadcast service, MBS, the second level QoE configuration being different from the first level QoE configuration item and associated with an application whose data is delivered by MBS; and
performing at least one action based on the received indication

Example D2. The method of Example D1, wherein the first level QoE configuration item indicates at least one of:
a service;
a service type;
a communication service;
a communication service type;
a delivery service;
a delivery method;
a delivery type;
a service delivery type;
a service type delivery;
a service type delivery method;
a traffic type;
a type of delivery method;
a service subtype;
a subservice type;
an indication indicating MBS;
an indication of a form of MBS; and
an indication of a hybrid delivery type.

Example D3. The method of Example D1, wherein the second level QoE configuration item indicates at least one of:
a service;
a session;
a service type;
a service subtype;
a subservice type;
a service one of in and over MBS;
a session one of in and over MBS;
a service type one of in and over MBS;
a service subtype one of in and over MBS; and
a subservice type one of in and over MBS.

Example D4. The method of any one of Examples D1-D3, wherein the first level QoE configuration item is a first radio access network, RAN, visible QoE, RVQoE, configuration item and the second level QoE configuration item is a second RVQoE configuration item.

Example D5. The method of any one of Examples D1-D4, wherein at least one of the first level QoE configuration item and second level QoE configuration item indicate QoE measurements are configured for MBS for one of a service type and predefined service types.

Example D6. The method of Example D5, wherein the service type and predefined service types include at least one of dynamic adaptive streaming over HTPP, DASH, streaming, a virtual reality and augmented reality.

Example D7. The method of any one of Examples D1-D6, wherein the indication of the first level QoE configuration item and second level QoE configuration item includes an indication whether one of MBS, broadcast, MBS broadcast, MBS multicast and unicast has been used to deliver data associated with a session of the application.

Example D8. The method of any one of Examples D1-D7, wherein the at least one action includes sending a QoE report to the network node, the QoE report indicating one of:
timestamps indicating a start time and/or end time for QoE measurements related to application session data delivered via one of MBS, unicast, MBS multicast and MBS broadcast; and
whether one of unicast and MBS has been used for delivery of at least a portion of the application session's data.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 3GPP | 3rd Generation Partnership Project |
| 5G | 5th Generation |
| 5GC | 5G Core |
| 5GS | 5th Generation System |
| AMF | Access and Mobility Management Function |
| AR | Augmented Reality |
| AS | Access Stratum |
| ASN.1 | Abstract Syntax Notation One |
| AT | Attention |
| CGI | Cell Global Identity |
| CHO | Conditional Handover |
| CN | Core Network |
| CP | Control Plane |
| C-RNTI | Cell RNTI |
| CU | Central Unit |
| DASH | Dynamic Adaptive Streaming over HTTP |
| DC | Dual Connectivity |
| DCI | Downlink Control Information |
| DL | Downlink |
| DRB | Data Radio Bearer |
| DU | Distributed Unit |
| EPC | Evolved Packet Core |
| EPS | Evolved Packet System |
| FDD | Frequency Division Duplex |
| gNB | Radio base station in NR |
| HARQ | Hybrid Automatic Repeat reQuest |
| HSS | Home Subscriber Server |
| HTTP | Hypertext Transfer Protocol |
| IAB | Integrated Access and Backhaul |
| ID | Identifier/Identity |
| IE | Information Element |
| IMS | IP Multimedia Subsystem |
| IP | Internet Protocol |
| LAI | Location Area Identifier |
| LTE | Long Term Evolution |
| MAC | Medium Access Control |
| MBMS | Multimedia Broadcast Multicast Service |
| MBS | Multicast Broadcast Services |
| MCC | Mobile Country Code |
| MCE | Measurement Collector Entity |
| MDT | Minimization of Drive Tests |
| MME | Mobility Management Entity |
| MNC | Mobile Network Code |
| MRB | MBS Radio Bearer |
| MTSI | Multimedia Telephony Service for IMS |
| NG | Next Generation/The interface between NG-RAN and |
| | 5GC. |
| NGAP | NG Application Protocol |
| NG-RAN | NG Radio Access Network |
| NR | New Radio |
| OAM, O&M | Operation and Maintenance |
| OAM | Operation and Maintenance |
| PDCP | Packet Data Convergence Protocol |
| PLMN | Public Land Mobile Network |
| PSCell | Primary Secondary Cell |
| PTP | Point-to-point |
| PTM | Point-to-multipoint |
| QMC | QoE Measurement Collection |
| QoE | Quality of Experience |
| RAI | Routing Area Identifier |
| RAN | Radio Access Network |
| RAT | Radio Access Technology |
| RB | Radio Bearer |
| RLC | Radio Link Control |
| RLF | Radio Link Failure |
| RNC | Radio Network Controller |
| RNTI | Radio Network Temporary Identity |
| RRC | Radio Resource Control |
| RVQoE | RAN Visible QoE |
| SCell | Secondary Cell |
| SN | Secondary Node |
| SN | Sequence Number |
| SRB | Signaling Radio Bearer |
| TAC | Tracking Area Code |
| TAI | Tracking Area Identifier |
| TCE | Trace Collector Entity |
| TDD | Time Division Duplex |
| TS | Technical Specification |
| UDM | Unified Data Management |
| UE | User Equipment |
| UMTS | Universal Mobile Telecommunication System |
| UP | User Plane |
| UPF | User Plane Function |
| VR | Virtual Reality |
| Xn | The interface between two gNBs in NR. |
| XnAP | Xn Application Protocol |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-58. (canceled)

59. A method performed by a wireless device, the wireless device configured to communicate with a network node, the method comprising:
receiving an indication of a first level quality of experience, QoE, configuration item for multicast and broadcast service, MBS, and a second level QoE configuration item for the MBS, the second level QoE configuration being different from the first level QoE configuration item and associated with an application whose data is delivered by the MBS; and
performing at least one action based on at least one of the first level QoE configuration item or the second level QoE configuration.

60. The method of claim 59, wherein the first level QoE configuration item indicates the MBS is one of:
a service type;
a communication service;
a communication service type; or
a delivery method.

61. The method of claim 59, wherein the second level QoE configuration item indicates at least one of:
a service delivered by the MBS;
a session delivered by the MBS;
a service type delivered by the MBS;
a service subtype delivered by the MBS; or
a subservice type delivered by the MBS.

62. The method of claim 59, wherein the first level QoE configuration item comprises one of a value or codepoint in at least one of:
a service type information element, IE, within an application layer measurement configuration procedure in radio resource control, RRC, signaling; or
wireless device application layer measurement configuration IE.

63. The method of claim 59, wherein the second level QoE configuration item comprises a set of values indicating a plurality of services types delivered via the MBS for which QoE measurements are requested.

64. The method of claim 59, further comprising receiving an indication of at least one of a QoE-related operation or a Radio Access Network visible QoE, RVQoE-related operation associated with the first level QoE configuration item and the second level QoE configuration item, the at least one of the QoE-related operation or the RVQoE-related operation comprises one of:
performing at least one of QoE measurements or RVQoE measurements for the MBS;
reporting of at least one of QoE measurements or RVQoE measurements for the MBS; or
performing alignment of at least one of QoE measurements or RVQoE measurements for the MBS with radio related measurements.

65. The method of claim 59, further comprising receiving an indication of at least one of a QoE-related operation or a Radio Access Network visible QoE, RVQoE-related operation associated with the first level QoE configuration item and the second level QoE configuration item, the indication of the at least one of the QoE-related operation or the RVQoE-related operation comprises an indication of change in the delivery of data for a service type, the change comprising one of:
a change from the MBS to unicast;
a change from unicast to the MBS;
a change from MBS multicast to unicast;
a change from MBS broadcast to unicast; or
a change from unicast to MBS broadcast.

66. The method of claim 59, further comprising receiving an indication of at least one of a QoE-related operation or a Radio Access Network visible QoE, RVQoE-related operation associated with the first level QoE configuration item and the second level QoE configuration item, the at least one of the QoE-related operation or the RVQoE-related operation indicating the delivery of the data by the MBS is to be one of:
enabled;
disabled;
continued;
discontinued;
paused; or
resumed.

67. The method of claim 59, wherein further comprising receiving an indication of at least one of a QoE-related operation or a Radio Access Network visible QoE, RVQoE-related operation associated with the first level QoE configuration item and the second level QoE configuration item, the at least one of the QoE-related operation or the RVQoE-related operation being related to mobility of the wireless device one of to or from a second network node;
the network node one of supports the MBS or does not support the MBS; and
the second network node one of supports the MBS or does not support the MBS.

68. The method of claim 67, wherein the indication of the at least one of the QoE-related operation or the RVQoE-related operation indicating delivery of the data by one of the MBS or unicast is to be one of:
enabled;
disabled;
continued;
discontinued;
paused; or
resumed.

69. The method of claim 67, wherein when the network node and the second network node do not support the MBS, the indication of the at least one of the QoE-related operation or the RVQoE-related operation indicating delivery of the data the MBS is to be one of:
enabled;
disabled;
continued;
discontinued;
paused; or
resumed.

70. A wireless device configured to communicate with a network node, the wireless device configured to:
receive an indication of a first level quality of experience, QoE, configuration item for multicast and broadcast service, MBS, and a second level QoE configuration item for the MBS, the second level QoE configuration being different from the first level QoE configuration item and associated with an application whose data is delivered by the MBS; and
perform at least one action based on at least one of the first level QoE configuration item or the second level QoE configuration.

71. The wireless device of claim 70, wherein the first level QoE configuration item indicates the MBS is one of:
a service type;
a communication service;
a communication service type; or
a delivery method.

72. A method performed by a network node, the network node configured to communicate with a wireless device, the method comprising:
one of receiving from another network node or determining a first level quality of experience, QoE, configuration item for multicast and broadcast service, MBS;
one of receiving from the other network node or determining a second level QoE configuration item for the MBS, the second level QoE configuration being different from the first level QoE configuration item and associated with an application whose data is delivered by the MBS; and
indicating, to the wireless device, the first level QoE configuration item and second level QoE configuration item for the wireless device (22) to perform an action based on at least one of the first level QoE configuration item or second level QoE configuration item.

73. The method of claim 72, wherein the first level QoE configuration item indicates the MBS is one of:
a service type;
a communication service;
a communication service type; or
a delivery method.

74. The method of claim 72, wherein the second level QoE configuration item indicates at least one of:
a service delivered by the MBS;
a session delivered by the MBS;
a service type delivered by the MBS;
a service subtype delivered by the MBS; or
a subservice type delivered by the MBS.

75. The method of claim 72, wherein the first level QoE configuration item comprises one of a value or codepoint in at least one of:
a service type information element, IE, within an application layer measurement configuration procedure in radio resource control, RRC, signaling; or
wireless device application layer measurement configuration IE.

76. The method of claim 72, wherein the second level QoE configuration item comprises a set of values indicating a plurality of services types delivered via the MBS for which QoE measurements are requested.

77. The method of claim 72, further comprising indicating at least one of a QoE-related operation or a Radio Access Network visible QoE, RVQoE-related operation for the wireless device to perform, the at least one of the QoE-related operation or the RVQoE-related operation is associated with the first level QoE configuration item and the second level QoE configuration item, the at least one of the QoE-related operation or the RVQoE-related operation comprises one of:
performing at least one of QoE measurements or RVQoE measurements for the MBS;
reporting of at least one of QoE measurements or RVQoE measurements for the MBS; or
performing alignment of at least one of QoE measurements or RVQoE measurements for the MBS with radio related measurements.

78. The method of claim 72, further comprising indicating at least one of a QoE-related operation or a Radio Access Network visible QoE, RVQoE-related operation associated with the first level QoE configuration item and the second level QoE configuration item, the indication of the at least one of the QoE-related operation or the RVQoE-related operation comprises an indication of change in the delivery of data for a service type, the change comprising one of:
a change from the MBS to unicast;
a change from unicast to the MBS;
a change from MBS multicast to unicast;
a change from MBS broadcast to unicast; or
a change from unicast to MBS broadcast.

79. The method of claim 72, further comprising indicating at least one of a QoE-related operation or a Radio Access Network visible QoE, RVQoE-related operation associated with the first level QoE configuration item and the second level QoE configuration item, the at least one of the QoE-related operation or the RVQoE-related operation indicating the delivery of the data by the MBS is to be one of:
enabled;
disabled;
continued;
discontinued;
paused; or
resumed.

80. The method of claim 72, further comprising indicating at least one of a QoE-related operation or a Radio Access Network visible QoE, RVQoE-related operation associated with the first level QoE configuration item and the second level QoE configuration item, the at least one of the QoE-related operation or the RVQoE-related operation being related to mobility of the wireless device one of to or from a second network node;
the network node one of supports the MBS or does not support the MBS; and
the second network node one of supports the MBS or does not support the MBS.

81. The method of claim 80, wherein the indication of the at least one of the QoE-related operation or the RVQoE-related operation indicating delivery of the data by one of the MBS or unicast is to be one of:
enabled;
disabled;
continued;
discontinued;
paused; or
resumed.

82. The method of claim 80, when the network node and the second network node do not support MBS, the indication of the at least one of the QoE-related operation or the RVQoE-related operation indicating delivery of the data by the MBS is to be one of:
enabled;
disabled;
continued;
discontinued;
paused; or
resumed.

83. A network node configured to communicate with a wireless device, the network node configured to:
one of receive from another network node or determine a first level quality of experience, QoE, configuration item for multicast and broadcast service, MBS;
one of receive from the other network node or determine a second level QoE configuration item for the MBS, the second level QoE configuration being different from the first level QoE configuration item and associated with an application whose data is delivered by the MBS; and
indicate, to the wireless device, the first level QoE configuration item and second level QoE configuration item for the wireless device to perform an action based on at least one of the first level QoE configuration item or second level QoE configuration item.

84. The network node of claim 83, wherein the first level QoE configuration item indicates the MBS is one of:
a service type;
a communication service;
a communication service type; or
a delivery method.
